(19) United States
(12) Patent Application Publication
(10) Pub. No.: US 2025/0193738 A1
(43) Pub. Date: Jun. 12, 2025

(54) METHOD AND APPARATUS FOR PERFORMING COMMUNICATION BY NETWORK FUNCTION IN WIRELESS COMMUNICATION SYSTEM

(71) Applicant: Samsung Electronics Co., Ltd., Suwon-si (KR)

(72) Inventors: Younggyoun MOON, Suwon-si (KR); Yoonseon HAN, Suwon-si (KR); Sunghwan KIM, Suwon-si (KR); Dongmyung KIM, Suwon-si (KR)

(21) Appl. No.: 18/978,738

(22) Filed: Dec. 12, 2024

(30) Foreign Application Priority Data
Dec. 12, 2023 (KR) 10-2023-0180093

(51) Int. Cl. H04W 28/10

(52) U.S. Cl. CPC H04W 28/10

(57) ABSTRACT

A 5^{th}-generation (5G) or 6^{th}-generation (6G) communication system for supporting higher data rates after the 4^{th}-generation (4G) communication system, such as long term evolution (LTE) is provided. A method performed by a session management function (SMF) in a wireless communication system is provided. The method includes configuring capacity information of a user plane function (UPF) based on at least one of information regarding a control message processing capability of the UPF or resource status information regarding control message processing, and controlling a flow of control messages to be transmitted to the UPF based on the capacity information of the UPF.

### CROSS-REFERENCE TO RELATED APPLICATION(S)

This application is based on and claims priority under 35 U.S.C. § 119 (a) of a Korean patent application number 10-2023-0180093, filed on Dec. 12, 2023, in the Korean Intellectual Property Office, the disclosure of which is incorporated by reference herein in its entirety.

### BACKGROUND

### 1. Field

The disclosure relates to a wireless communication system. More particularly, the disclosure relates to a method and apparatus for performing communication by a network function (NF) including a session management function (SMF) and a user plane function (UPF).

### 2. Description of the Related Art

Looking back through successive generations at a process of development of radio communication, technologies for human-targeted services, such as voice, multimedia, data or the like have been developed. Connected devices that are on the explosive rise after commercialization of 5^{th} generation (5G) communication systems are expected to be connected to communication networks. As examples of things connected to networks, there may be cars, robots, drones, home appliances, displays, smart sensors installed in various infrastructures, construction machinery, factory equipment, or the like. Mobile devices are expected to evolve into various form factors, such as augmentation reality (AR) glasses, virtual reality (VR) headsets, hologram devices, and the like. In order to provide various services by connecting hundreds of billions of devices and things in the 6^{th}-generation (6G) era, there are ongoing efforts to develop better 6G communication systems. For these reasons, 6G communication systems are referred to as beyond-5G systems.

In the 6G communication system expected to become a reality by around 2030, a maximum transfer rate is tera bits per second (bps), i.e., 1000 giga bps, and a maximum wireless delay is 100 micro seconds (usec). In other words, in the 6G communication system, the transfer rate becomes 50 times faster and the wireless delay is reduced to a one-tenth of the 5G communication system.

To attain these high data transfer rates and ultra-low delay, the 6G communication system is considered to be implemented in the terahertz (THz) band (e.g., ranging from 95 gigahertz (GHz) to 3 THz). Due to the more severe path loss and atmospheric absorption phenomenon in the THz band as compared to the millimeter wave (mmWave) band introduced in 5G systems, importance of technology for securing a signal range, i.e., coverage, is expected to grow. As major technologies for securing coverage, radio frequency (RF) elements, antennas, new waveforms superior to orthogonal frequency division multiplexing (OFDM) in terms of coverage, beamforming and massive multiple-input and multiple-output (massive MIMO), full dimensional MIMO (FFD-MIMO), array antennas, multiple antenna transmission technologies, such as large scale antennas, or the like, need to be developed. Besides, new technologies for increasing coverage of THz band signals, such as metamaterial based lenses and antennas, a high-dimensional spatial multiplexing technique using orbital angular momentum (OAM), reconfigurable intelligent surface (RIS), or the like, are being discussed.

Furthermore, in order to enhance frequency efficiency and system networks, a full duplex technology by which both uplink and downlink transmissions use the same frequency resource at the same time, a network technology that comprehensively uses satellite and high-altitude platform stations (HAPS) and the like, a network structure innovation technology supporting mobile base stations and allowing optimization and automation of network operation, a dynamic spectrum sharing technology through collision avoidance based on spectrum usage prediction, an artificial intelligence (AI) based communication technology to realize system optimization by using AI from the designing stage and internalizing an end-to-end AI supporting function, a next generation distributed computing technology to realize services having complexity beyond the limit of terminal computing capability by using ultrahigh performance communication and computing resources (e.g., mobile edge computing (MEC) cloud) are being developed in the 6G communication system. In addition, by designing new protocols to be used in 6G communication systems, developing mechanisms for implementing a hardware-based security environment and safe use of data, and developing technologies for protecting privacy, attempts to strengthen connectivity between devices, further optimize the network, promote softwarization of network entities, and increase the openness of wireless communication are continuing.

With such research and development of the 6G communication system, it is expected that new levels of the next hyper-connected experience become possible through hyper-connectivity of the 6G communication system including not only connections between things but also connections between humans and things. Specifically, it is predicted that services, such as truly immersive extended reality (truly immersive XR), high-fidelity mobile hologram, digital replication, or the like, may be provided. Furthermore, services, such as remote surgery, industrial automation and emergency response with enhanced security and reliability may be provided through the 6G communication system to be applied in various areas, such as industry, medical care, vehicles, appliances, or the like.

The amount of traffic to be handled in a mobile communication network is growing every year, and there are increasing requirements with the change in generation of the mobile communication technology. For example, in 6G mobile communication, more and more user equipments (UEs) need to generate and transmit larger volumes of data to use various applications.

Recently, network functions in a communication system including a base station (BS) and a core network are being softwarized or virtualized. This may bring benefits of horizontal scaling depending on traffic loads, increasing resource efficiency and reduction in time required to add or upgrade a new function, but in return, the traffic may increase rapidly and performance and energy limits may be reached.

Hence, there is a growing need for a new technology to efficiently handle the traffic by taking into account network bandwidth and traffic requirements at a time of 6G commercialization.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for performing communication by a network function (NF) including a session management function (SMF) and a user plane function (UPF).

Additional aspects will be set forth in part in the description which follows and, in part, will be apparent from the description, or may be learned by practice of the presented embodiments.

In accordance with an aspect of the disclosure, a method performed by a session management function (SMF) in a wireless communication system is provided. The method includes configuring capacity information of a user plane function (UPF) based on at least one of information regarding a control message processing capability of the UPF or resource status information regarding control message processing, and controlling a flow of control messages to be transmitted to the UPF based on the capacity information of the UPF.

In accordance with another aspect of the disclosure, an SMF in a wireless communication system is provided. The SMF includes a transceiver, and at least one processor connected to the transceiver, wherein the at least one processor is configured to configure capacity information of a UPF based on at least one of information regarding a control message processing capability of the UPF or resource status information regarding control message processing, and control a flow of control messages to be transmitted to the UPF based on the capacity of the UPF.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates interaction between a session management function (SMF) and a user plane function (UPF) according to an embodiment of the disclosure;

FIG. 2 illustrates registering of a UPF in a network repository function (NRF) according to an embodiment of the disclosure;

FIG. 3 illustrates an SMF obtaining information from an NRF according to an embodiment of the disclosure;

FIG. 4 illustrates an SMF obtaining information from a network data analytics function (NWDAF) according to an embodiment of the disclosure;

FIG. 5 illustrates the exchange of information between an SMF and a UPF according to an embodiment of the disclosure;

FIG. 6 illustrates an SMF selecting a UPF according to an embodiment of the disclosure;

FIG. 7 is a sequence diagram of operations of an SMF and a UPF according to an embodiment of the disclosure;

FIGS. 8 and 9 are diagrams illustrating how an SMF controls flows of rule update messages according to various embodiments of the disclosure;

FIG. 10 illustrates sending messages on a priority basis according to an embodiment of the disclosure;

FIG. 11 illustrates priority-based message offloading according to an embodiment of the disclosure;

FIG. 12 is a block diagram of a network entity according to an embodiment of the disclosure; and

FIG. 13 is a block diagram of a network entity according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

Before starting “detailed description”, particular terms and phrases used throughout this specification will now be defined first.

The term “couple” and derivatives thereof refer to any direct or indirect communication between two or more elements no matter whether the elements physically come into contact with each other. Not only the terms “transmit”, “receive” and “communicate” but also their derivatives include both direct communication and indirect communication. The terms “include” and “comprise” as well as derivatives thereof mean inclusion without limitation.

The term “or” is inclusive and refers to “and/or”. The phrase “related to A” and derivatives thereof refer to “include A”, “included in A”, “interconnect with A”, “contain A”, “contained in A”, “connect to or with A”, “couple to or with A”, “communicate with A”, “cooperate with A”, “interleave A”, “juxtapose A”, “approach A”, “associated to or with A”, “have A”, “characterized by A”, “have a relation to or with A”, or the like.

In the disclosure, when the term “connected” or “coupled” is used, a component may be directly connected or coupled to another component. However, unless otherwise defined, it is also understood that the component may be indirectly connected or coupled to the other component via another new component.

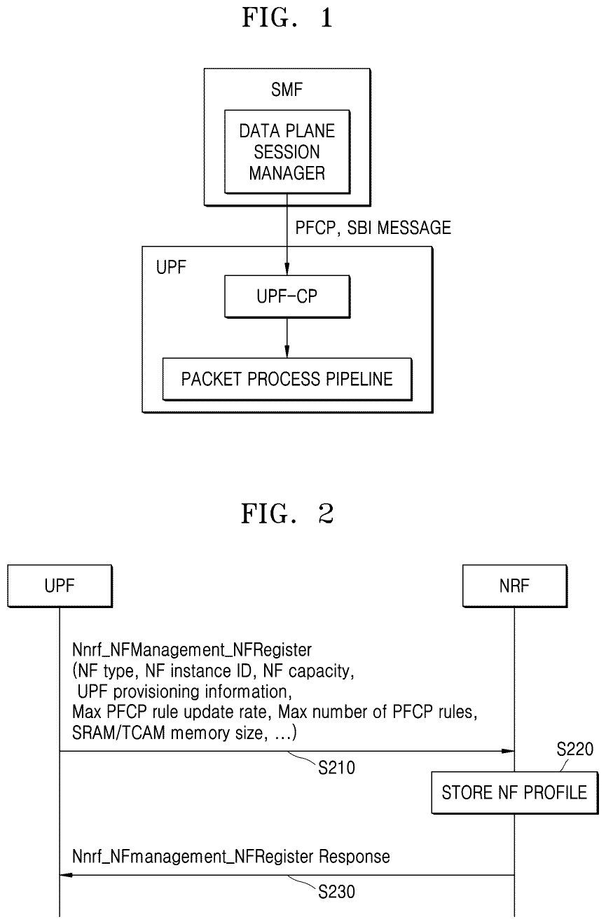

Various modifications may be made to embodiments of the disclosure, which will be described more fully hereinafter with reference to the accompanying drawings. FIGS. 1 to 13 and various embodiments used to explain principles of the disclosure in this specification, as will be described below, are merely examples, and should not be construed as limiting the scope of the disclosure in any case.

Those of ordinary skill in the art will appreciate that the principles of the disclosure may be implemented in any system or device arranged in suitable manner. Those of ordinary skill in the art will also understand that the principles of the disclosure can be implemented in any suitably arranged wireless communication system.

For the same reason, some parts in the accompanying drawings are exaggerated, omitted or schematically illustrated. The size of the respective elements may not fully reflect their actual size. Ordinal numbers (e.g., first, second, or the like) as herein used are to distinguish components from one another.

Advantages and features of the disclosure, and methods for achieving them will be understood more clearly when the following embodiments are read with reference to the accompanying drawings. The embodiments of the disclosure may, however, be embodied in many different forms and should not be construed as limited to the embodiments set forth herein. Rather, these embodiments of the disclosure are provided so that this disclosure will be thorough and complete, and will fully convey the scope of the embodiments of the disclosure to those of ordinary skill in the art. Like numbers refer to like elements throughout the specification.

A base station (BS) as herein used may refer to an entity for performing resource allocation for a user equipment (UE) and may be at least one of gNode B, eNode B, Node B (or xNode B, where x represents any letter including ‘g’ and ‘e’), a radio access unit, a BS controller, a satellite, an airborne vehicle or a node in a network. In the disclosure, a BS may be interchangeably used with a network.

A UE may include a mobile station (MS), a vehicle, a satellite, an airborne vehicle, a cellular phone, a smart phone, a computer, or a multimedia system having a communication function.

Furthermore, in the disclosure, a cell may refer to an area covered by a single BS in wireless communication. The cell may be classified into a mega cell, a macro cell, a micro cell, a pico cell, or the like, without being limited thereto.

In the disclosure, a downlink (DL) may refer to a radio transmission path for a signal transmitted from a BS to a UE, and an uplink (UL) may refer to a radio transmission path for a signal transmitted from a UE to a BS. In addition, there may be a sidelink (SL) that refers to a radio transmission path for a signal transmitted from a UE to another UE.

In the following description, the terms referring to broadcast information, control information, state changes (e.g., events), network entities, messages, and components of an apparatus, the terms related to communication coverage, or the like, are mentioned for convenience of explanation.

Although the following embodiments of the disclosure will be focused on the long term evolution (LTE), LTE-Advanced (LTE-A) or a 5^{th} generation (5G) system as an example, they may be applied to other communication systems with similar technical backgrounds or channel types. For example, the other communication systems may include a 5G-Advanced, new radio (NR)-Advanced or 6^{th} generation (6G or beyond 5G) mobile communication technology developed after the 5G mobile communication technology (or NR), and the term 5G may be a concept including the existing long term evolution (LTE), LTE-Advanced (LTE-A) and other similar services. Furthermore, embodiments of the disclosure will also be applied to different communication systems with some modifications to such an extent that does not significantly deviate the scope of the disclosure when judged by skilled people in the art.

In the following description, for convenience of explanation, terms and definitions used in the most recent standards among the currently existing communication standards, i.e., in the LTE and NR standards defined in the 3rd Generation Partnership Project (3GPP) will be used. The disclosure is not, however, limited to the aforementioned terms and definitions, and may be equally applied to any wireless communication systems that conform to other standards.

For example, although embodiments of the disclosure will now be focused on the 6G wireless communication technology as an example, they may be applied to other wireless communication systems with similar technical backgrounds or channel types. In another example, embodiments of the disclosure may be equally applied to such wireless communication systems as NR, LTE or LTE-A before NR, and may further be applied to a wireless communication system developed after NR.

Embodiments of the disclosure may be supported by standard documents disclosed in at least one of the 3GPP or 3GPP2 related to wireless access systems. In the embodiments of the disclosure, operations or parts that are omitted to clarify the technical concept of the disclosure may also be supported by the documents.

Furthermore, although embodiments of the disclosure will be primarily focused on a radio access network, New RAN (NR), and a core network, packet core (5G system, 5G core network, or next generation (NG) core) in a 5G mobile communication standard specified by the third generation partnership project (3GPP), the subject matter of the disclosure may also be applicable to other communication systems with a similar technical background with minor changes without significantly departing from the scope of the disclosure, which may be possible under the determination of those of ordinary skill in the art to which the disclosure pertains.

The disclosure is not limited to the terms as will be used in the following description, and may use different terms having the same meaning in a technological sense.

In the following description, a session management function (SMF) will be described as an example for convenience of explanation, but the embodiments of the disclosure will be equally applied to an entity that serves as a controller in a control plane and an entity that controls packet flows. Furthermore, a user plane function (UPF) will be described as an example for convenience of explanation, but the embodiments of the disclosure will be equally applied to an entity located in a data plane, a data processing entity and an entity that handles packet flows.

Interface between the SMF and the UPF will now be described by taking an example of an N4 session for convenience of explanation, but the interface between the SMF and the UPF may be equally applied to a data plane session, service based interface (SBI) or other interfaces between the SMF and the UPF.

For example, the SMF and the UPF may establish the N4 session by using a packet forwarding control protocol (PFCP), which may be represented in the form of a PFCP extended message. The SMF and the UPF may use an SBI interface for forwarding information, which may be represented in the form of a message that uses the SBI interface.

It will be understood that each block and combination of the blocks of a flowchart may be performed by computer program instructions. The computer program instructions may be loaded onto a processor of a universal computer, a special-purpose computer, or other programmable data processing equipment, and thus they generate means for performing functions described in the block(s) of the flowcharts when executed by the processor of the computer or other programmable data processing equipment.

The computer program instructions may also be stored in computer-executable or computer-readable memory that may direct the computers or other programmable data processing apparatus to function in a particular manner, such that the instructions stored in the computer-executable or computer-readable memory may produce an article of manufacture including instruction means that perform the functions specified in the flowchart blocks(s).

The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Furthermore, each block may represent a part of a module, segment, or code including one or more executable instructions to perform particular logic function(s). It is noted that the functions described in the blocks may occur out of order in some alternative embodiments.

For example, two successive blocks may be performed substantially at the same time or in reverse order depending on the corresponding functions.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors.

For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables.

Functions served by components and modules may be combined into a small number of components and modules, or further divided into a larger number of components and modules. Moreover, the components and modules may be implemented to execute one or more central processing units (CPUs) in a device or security multimedia card. In embodiments of the disclosure, the module may include one or more processors.

The performance of a control plane may have influence on the performance of a data plane, and when there is congestion, it may cause a delay in updating rules of the control plane. For example, when a speed of updating the rules of the control plane decreases, the performance of the data plane may be reduced.

In an embodiment of the disclosure, in an interaction procedure between the SMF and the UPF, capacity or throughput of the UPF related to a command issued by the SMF to the UPF may be taken into account. When an entity that serves as a controller located in a control plane of the mobile communication system controls an entity located in the user plane or data plane, it may prevent or reduce performance deterioration of the data plane itself that might occur due to frequent changes in control message.

In addition, occurrences of the congestion in the control plane may be reduced by putting priority on the process of the command of the control plane. Through a method of applying a particular command first, control over the data plane may be performed more efficiently.

In an embodiment of the disclosure, there are a UPF that processes data packets and an SMF that controls rules related to data packet processing, and specifically, entities that act on selection of the SMF and the UPF, such as a service communication proxy (SCP) and a network repository function (NRF) for supporting discovery of a network function (NF) may be provided to perform a specific embodiment of the disclosure.

Hereinafter, the phrase “flow and session” may refer to a set of traffics having the same characteristics. For example, in the communication system, a packet data unit (PDU) session may be included to connect between the UE and the core network for traffic transmission and reception. The PDU session may include a quality of service (QOS) flow, which is a minimum unit for identifying QoS.

In the disclosure, the updating of rules may include adding, dropping, and modifying one or more of the installed rules.

The rules may be included in a control message that defines an operation method of the UPF. The control message may be sent from the SMF to the UPF. The rules may include at least one of packet detection rules (PDR), forwarding action rules (FAR), multi-access rules (MAR), usage reporting rules (URR), QOS enforcement rules (QER), or session reporting rules (SRR). For example, when the SMF and the UPF transmit or receive messages through the N4 session, a packet forwarding control protocol (PFCP) may be used.

The PDR may include information for classifying the traffic (e.g., packet data units (PDU)) that arrives at the UPF. The PDR may be used to detect a packet transmitted from a certain direction, such as the UL direction or the DL direction. For example, the PDR may be structured as in Table 1 below.

TABLE 1

| Attribute | | Description | Comment |
|---|---|---|---|
| N4 Session ID | | Identifies the N4 session associated to | |
| | | this PDR. NOTE 5. | |
| Rule ID | | Unique identifier to identify this rule. | |
| Precedence | | Determines the order, in which the | |
| | | detection information of all rules is | |
| | | applied. | |
| Packet | Source | Contains the values “access side”, “core | Combination of UE IP |
| | interface | side”, “SMF”, “N6-LAN”, “5G VN | address (together with |
| | | internal”. | Network instance, if |
| | | | necessary), CN tunnel |
| | | | info, |
| Detection | UE IP | One IPv4 address and/or one IPv6 | packet filter set, |
| | address | prefix with prefix length (NOTE 3). | application identifier, |
| | | | Ethernet PDU Session |
| Information. | Network | Identifies the Network instance | Information and QFI |
| NOTE 4. | instance | associated with the incoming packet. | are used for traffic |
| | (NOTE 1) | | detection. |
| | | | Source interface |
| | | | identifies the |
| | CN tunnel | CN tunnel info on N3, N9 interfaces, | interface for incoming |
| | info | i.e., F-TEID. | packets |
| | Packet | Details see clause 5.7.6. | where the PDR |
| | Filter Set | | applies, e.g., from |
| | | | access side (i.e., |
| | | | up-link), |
| | Application | | from core side (i.e., |
| | identifier | | down-link), |
| | QoS Flow | Contains the value of 5QI or non- | from SMF, from N6- |
| | ID | standardized QFI. | LAN (i.c., the |
| | Ethernet | Refers to all the (DL) Ethernet packets | DN), or from “5G VN |
| | PDU | matching an Ethernet PDU session, as | internal” (i.e., local |
| | Session | further described in clause 5.6.10.2 | switch). |
| | Information | and in TS 29.244 [65]. | |
| | Framed | Refers to Framed Routes defined in | Details like all the |
| | Route | clause 5.6.14. | combination |
| | Information | | possibilities on N3, N9 |
| | | | interfaces are left for |
| | | | stage 3 decision. |
| | FQDN | Contains one or more FQDN, FQDN | The FQDN or FQDN |
| | Filter for | range, and/or any FQDN. | range only used for |
| | DNS Query | | detection of plain DNS |
| | | | Query message (i.e., |
| | | | not subject to |
| | | | ciphering). The usage |
| | | | is described in TS |
| | | | 23.548 [130]. |
| | Protocol | Indicates service protocol used by the | |
| | Description | flow (NOTE 8). | |
| Packet | Packet | Contains UE address indication or | |
| replication | replication | N19/N6 indication. If the packet | |
| and | skip | matches the packet replication skip | |
| detection | information | information, i.e., source address of the | |
| carry on | NOTE 7 | packet is the UE address or the packet | |
| information | | has been received on the interface in | |
| | | the packet replication skip information, | |
| | | the UP function neither creates a copy | |
| | | of the packet nor applies the | |
| | | corresponding processing (i.e., FAR, | |
| | | QER, URR). Otherwise the UPF | |
| | | performs a copy and applies the | |
| | | corresponding processing (i.e., FAR, | |
| | | QER, URR). | |
| NOTE 6 | Carry on | Instructs the UP function to continue | |
| | indication | the packet detection process, i.e., | |
| | | lookup of the other PDRs. | |

| Outer header | Instructs the UP function to remove one | Any extension header |
|---|---|---|
| removal | or more outer header(s) (e.g., | shall be stored for this |
| | | packet. |
| | IP + UDP + GTP, IP + possibly UDP, | |
| | VLAN tag), from the incoming packet. | |
| Forwarding Action | The Forwarding Action Rule ID | |
| Rule ID (NOTE 2) | identifies a forwarding action that has | |
| | to be applied. | |
| Multi-Access | The Multi-Access Rule ID identifies an | |
| Rule ID | action to be applied for handling | |
| (NOTE 2) | forwarding for a MA PDU Session. | |
| List of Usage | Every Usage Reporting Rule ID | |
| Reporting Rule | identifies a measurement action that has | |
| ID(s) | to be applied. | |
| List of QoS | Every QoS Enforcement Rule ID | |
| Enforcement | identifies a QoS enforcement action | |
| Rule ID(s) | that has to be applied. | |

The FAR may include information about whether to forward, drop or buffer the traffic identified with the PDR. The FAR may refer to how to buffer, drop or forward a packet including packet encapsulation/decapsulation and forwarding destination. For example, the FAR may be structured as in Table 2 below.

TABLE 2

| Attribute | Description | Comment |
|---|---|---|
| N4 Session ID | Identifies the N4 session associated to | NOTE 9. |
| | this FAR. | |
| Rule ID | Unique identifier to identify this | |
| | information. | |
| Action | Identifies the action to apply to the | Indicates whether the |
| | packet | packet is to be |
| | | forwarded, duplicated, |
| | | dropped or buffered. |
| | | When action indicates |
| | | forwarding or |
| | | duplicating, a number of |
| | | additional attributes are |
| | | included in the FAR. |
| | | For buffering action, a |
| | | Buffer Action Rule is |
| | | also included and the |
| | | action can also indicate |
| | | that a notification of the |
| | | first buffered and/or a |
| | | notification of first |
| | | discarded packet is |
| | | requested (see clause |
| | | 5.8.3.2). |
| | | For drop action, a |
| | | notification of the |
| | | discarded packet may be |
| | | requested (see clause |
| | | 5.8.3.2). |
| Network | Identifies the Network instance | NOTE 8. |
| instance(NOTE 2) | associated with the outgoing packet | |
| | (NOTE 1). | |
| Destination | Contains the values “access side”, | Identifies the interface |
| interface(NOTE 3) | “core side”, “SMF”, “N6-LAN”, | for outgoing packets |
| (NOTE 7) | “5G VN internal”. | towards the access side |
| | | (i.e., down-link), the |
| | | core side (i.e., up-link), |
| | | the SMF, the N6-LAN |
| | | (i.e., the DN), or to 5G |
| | | VN internal (i.e., local |
| | | switch). |
| Outer header | Instructs the UP function to add an | Contains the CN tunnel |
| creation(NOTE 3) | outer header (e.g., IP + UDP + GTP, | info, N6 tunnel info or |
| | VLAN tag), IP + possibly UDP to the | AN tunnel info of peer |
| | outgoing packet. | entity (e.g., NG-RAN, |
| | | another UPF, SMF, local |
| | | access to a DN |
| | | represented by a DNAI) |
| | | (NOTE 8). |
| | | Any extension header |
| | | stored for this packet |
| | | shall be added. |
| | | The time stamps should |
| | | be added in the GTP-U |
| | | header if QoS |
| | | Monitoring for packet |
| | | delay is enabled for the |
| | | traffic corresponding to |
| | | the PDR(s). |
| Send end marker | Instructs the UPF to construct end | This parameter should be |
| packet(s)(NOTE 2) | marker packet(s) and send them out as | sent together with the |
| | described in clause 5.8.1. | “outer header creation” |
| | | parameter of the new CN |
| | | tunnel info. |
| Transport level | Transport level packet marking in the | NOTE 8. |
| marking(NOTE 3) | uplink and downlink, e.g., setting the | |
| | DiffServ Code Point. | |
| Forwarding | Reference to a preconfigured traffic | The Forwarding policy |
| policy(NOTE 3) | steering policy or http redirection | refers to a preconfigured |
| | (NOTE 4). | forwarding behaviour in |
| | | UPF, which may be |
| | | related to: |
| | | N6-LAN steering |
| | | to steer the subscriber's |
| | | traffic to the appropriate |
| | | N6 Service Functions |
| | | deployed by the |
| | | operator; |
| | | local N6 steering |
| | | to enable traffic steering |
| | | in the local access to the |
| | | DN according to the |
| | | routing information |
| | | provided by an AF as |
| | | described in clause |
| | | 5.6.7; |
| | | a Redirect |
| | | Destination and values |
| | | for the forwarding |
| | | behaviour (always, after |
| | | measurement report (for |
| | | termination action |
| | | “redirect”)). |
| Metadata(NOTE 10) | Metadata the UPF needs to add to | The metadata |
| | traffic sent over an SFC. | information is associated |
| | | with a TSP ID related to |
| | | N6-LAN steering. |
| Request for Proxying | Indicates that the UPF shall perform | Applies to the Ethernet |
| in UPF | ARP proxying and/or IPv6 Neighbour | PDU Session type. |
| | Solicitation Proxying as specified in | |
| | clause 5.6.10.2. | |
| Container for header | Contains information to be used by | Only relevant for the |
| enrichment(NOTE 2) | the UPF for header enrichment. | uplink direction. |
| Buffering Action | Reference to a Buffering Action Rule | |
| Rule(NOTE 5) | ID defining the buffering instructions | |
| | to be applied by the UPF | |
| | (NOTE 6) | |

The URR may include information indicating a method of describing the traffic identified with the PDR, a method of calculating a packet, and when and how to report measurements. For example, the URR may be structured as in Table 3 below.

TABLE 3

| Attribute | Description | Comment |
|---|---|---|
| N4 Session ID | Uniquely identifies a session. | Identifies the N4 session |
| | | associated to this Usage |
| | | Report |
| Rule ID | Uniquely identifies the Packet | Packet Detection Rule is |
| | Detection Rule or Usage Reporting | only indicated when |
| | Rule within a session which triggered | Reporting trigger is |
| | the report. | Start/stop of traffic |
| | | detection. Usage |
| | | Reporting Rule is |
| | | indicated for all other |
| | | Reporting triggers. |
| Reporting trigger | Identifies the trigger for the usage | Applicable values |
| | report. | are: Start/stop of traffic |
| | | detection with/without |
| | | application instance |
| | | identifier and deduced |
| | | SDF filter reporting; |
| | | Deletion of last PDR for |
| | | a URR; Periodic |
| | | measurement threshold |
| | | reached; |
| | | Volume/Time/Event |
| | | measurement threshold |
| | | reached; Immediate |
| | | report requested; |
| | | Measurement of |
| | | incoming UL traffic; |
| | | Measurement of |
| | | discarded DL traffic; |
| | | MAC address reporting |
| | | in the UL traffic; |
| | | reporting of unknown |
| | | destination MAC/IP |
| | | address; end marker |
| | | packet has been received. |
| Start time | Provides the timestamp, in terms of | Not sent when Reporting |
| | absolute time, when the collection of | trigger is Start/stop of |
| | the information provided within | traffic detection. |
| | Usage-Information is started. | |
| End time | Provides the timestamp, in terms of | Not sent when Reporting |
| | absolute time, when the information | trigger is Start/stop of |
| | provided within Usage-Information is | traffic detection. |
| | generated. | |
| Measurement | Defines the measured | For details refer to clause |
| information | volume/time/events for this URR. | 7.5.8.3 of TS 29.244 [65]. |
| Other information | Other events/information, e.g., related | For details refer to clause |
| | to reporting of UE MAC addresses. | 7.5.8.3 of TS 29.244 [65]. |

The QER may include information relating to QoS application of the traffic identified by the PDR. The QER may indicate how to process a packet in terms of packet indication and restriction of bit transfer rates for the purpose of QoS. For example, the QER may be structured as in Table 4 below.

TABLE 4

| Attribute | Description | Comment |
|---|---|---|
| N4 Session ID | Identifies the N4 session associated | |
| | to this QER | |
| Rule ID | Unique identifier to identify this | |
| | information. | |
| QOS Enforcement | An identity allowing the UP function | Is used to correlate QoS |
| Rule correlation ID | to correlate multiple Sessions for the | Enforcement Rules for |
| (NOTE 1) | same UE and APN. | APN-AMBR |
| | | enforcement. |
| Gate status UL/DL | Instructs the UP function to let the | Values are: open, close, |
| | flow pass or to block the flow. | close after measurement |
| | | report (for termination |
| | | action “discard”). |
| Maximum bitrate | The uplink/downlink maximum | This field may e.g., |
| | bitrate to be enforced for the packets. | contain any one of:- |
| | | APN-AMBR (for |
| | | a QER that is referenced |
| | | by all relevant Packet |
| | | Detection Rules of all |
| | | PDN Connections to an |
| | | APN) (NOTE 1). |
| | | Session-AMBR |
| | | (for a QER that is |
| | | referenced by all relevant |
| | | Packet Detection Rules |
| | | of the PDU Session) |
| | | QoS Flow MBR |
| | | (for a QER that is |
| | | referenced by all Packet |
| | | Detection Rules of a QoS |
| | | Flow) |
| | | SDF MBR (for a |
| | | QER that is referenced |
| | | by the uplink/downlink |
| | | Packet Detection Rule of |
| | | a SDF) |
| | | Bearer MBR (for a |
| | | QER that is referenced |
| | | by all relevant Packet |
| | | Detection Rules of a |
| | | bearer) (NOTE 1). |
| Guaranteed bitrate | The uplink/downlink guaranteed | This field contains:- |
| | bitrate authorized for the packets. | QoS Flow GBR (for a QER |
| | | that is referenced by all |
| | | Packet Detection Rules |
| | | of a QoS Flow) |
| | | Bearer GBR (for a |
| | | QER that is referenced |
| | | by all relevant Packet |
| | | Detection Rules of a |
| | | bearer) (NOTE 1). |
| Averaging window | The time duration over which the | This is for counting the |
| | Maximum and Guaranteed bitrate | packets received during |
| | shall be calculated. | the time duration. |
| Down-link flow level | Flow level packet marking in the | For UPF, this is for |
| marking | downlink. | controlling the setting of |
| | | the RQI in the |
| | | encapsulation header as |
| | | described in clause |
| | | 5.7.5.3. |
| QoS Flow ID | QoS Flow ID to be inserted by the | The UPF inserts the QFI |
| | UPF. | value in the tunnel header |
| | | of outgoing packets. |
| Paging Policy | Indicates the PPI value the UPF is | PPI applies only for DL |
| Indicator | required to insert in outgoing packets | traffic. The UPF inserts |
| | (see clause 5.4.3.2). | the PPI in the outer |
| | | header of outgoing PDU. |
| Packet rate | Number of packets per time interval | This field contains any |
| (NOTE 1) | to be enforced. | one of:- |
| | | downlink packet rate for |
| | | Serving PLMN Rate Control |
| | | (the QER is referenced by |
| | | all PDRs of the UE |
| | | belonging to PDN |
| | | connections using CIOT |
| | | EPS Optimisations as |
| | | described in TS 23.401 |
| | | [26]). |
| | | uplink/downlink |
| | | packet rate for APN Rate |
| | | Control (the QER is |
| | | referenced by all PDRs |
| | | of the UE belonging to |
| | | PDN connections to the |
| | | same APN using CIOT |
| | | EPS Optimisations as |
| | | described in TS 23.401 |
| | | [26]). |
| End of Data Burst | Indicates to the UPF to provide an | NG-RAN can configure |
| Marking Indication | End of Data Burst indication of the | UE power management |
| | last PDU of a Data burst to the NG- | schemes like connected |
| | RAN over GTP-U | mode DRX when UPF |
| | | provides an indication of |
| | | the End of Data Burst, |
| | | see clause 5.37.8.3. |
| PDU Set Information | Indicates the UPF to insert PDU Set | UPF identifies PDU Sets |
| marking Indicator | Information related to packets | in DL traffic and |
| | belonging to a PDU Set into GTP-U | forwards PDU Set related |
| | header. | information of each PDU |
| | | to the NG-RAN over |
| | | GTP-U, as described in |
| | | clause 5.37.5. |

The MAR may include information about a method of processing traffic control, switching and segmentation for an MA PDU session. The SRR may include information requesting an UP function to detect and report an event for a PDU session irrelevant to a certain PDR or irrelevant to traffic usage measurement. For example, the MAR may be structured as in Table 5 below.

TABLE 5

| Attribute | | Description | Comment |
|---|---|---|---|
| N4 Session ID | | Identifies the N4 session associated to | |
| | | this MAR. | |
| Rule ID | | Unique identifier to identify this rule. | |
| Steering | | | |
| functionality | | Indicates the applicable traffic | |
| (NOTE 5) | | steering functionality: | |
| | | Values “MPTCP functionality”, | |
| | | “ATSSS-LL functionality”, | |
| | | “MPQUIC functionality”. | |
| Transport Mode | | Identifies the transport mode (see | The Transport Mode |
| | | clause 5.32.6.2.2.1) that should be | shall be included only |
| | | used for the matching traffic, when | when the Steering |
| | | the Steering functionality is the | Functionality is the |
| | | MPQUIC functionality. | MPQUIC |
| | | | functionality. In all |
| | | | other cases, the |
| | | | Transport Mode shall |
| | | | not be included. |
| Steering mode | | Values “Active-Standby”, “Smallest | |
| (NOTE 5) | | Delay”, “Load Balancing”, or | |
| | | 'Priority-based” or “Redundant”. | |
| Steering Mode | | Indicates either autonomous load- | |
| Indicator(NOTE 4) | | balance operation or UE-assistance | |
| | | operation if steering mode is set to | |
| | | “Load Balancing”. | |
| Threshold values | | A Maximum RTT and/or a Maximum | The Threshold Values |
| (NOTE 3, NOTE 4) | | Packet Loss Rate | are applied by UPF as |
| | | | described in clause |
| | | | 5.32.8. |
| Per-Access | Forwarding | The Forwarding Action Rule ID | |
| Forwarding | Action Rule | identifies a forwarding action that has | |
| | ID | to be applied. | |
| Action | Weight | Identifies the weight for the FAR if | The weights for all |
| information | | steering mode is “Load Balancing” | FARs need to sum up |
| | | | to 100 |
| (NOTE 1) | Priority | Values “Active or Standby” or “High | “Active or Standby” |
| (NOTE 2) | | or Low” for the FAR | for “Active-Standby” |
| | | | steering mode and |
| | | | “High or Low” for |
| | | | “Priority-based” |
| | | | steering mode |
| | List of | Every Usage Reporting Rule ID | This enables the SMF |
| | Usage | identifies a measurement action that | to request separate |
| | Reporting | has to be applied. | usage reports for |
| | Rule ID(s) | | different FARs (i.e., |
| | | | different accesses) |

In an embodiment of the disclosure, 5G or an NR core network may include various NFs. 5G or the NR core network may include more or less NFs than NFs as will be described below.

An access and mobility management function (AMF) is a device for managing access and mobility of a UE, and may serve as a UE-core network endpoint for the UE to connect to other devices in the core network through a radio access network (RAN). Functions provided by the AMF may include e.g., management of registration, connection, reachability and mobility of the UE, access confirmation/authentication, mobility event generation, or the like.

A session management function (SMF) may perform a function of managing a PDU session of the UE. For example, the SMF may perform session management functions for session establishment, modification, release, or associated tunnel maintenance between the UPF and an access network (AN), functions for IP address allocation and management for the UE, an address resolution protocol (ARP) proxy function, and functions, such as user plane selection and control, traffic processing control in the UPF, charging data collecting control, or the like.

A policy control function (PCF) may serve to determine and issue a policy for access/mobility and session management to be applied to the AMF and the SMF. For example, the PCF may govern all the behaviors of a network and provide policies to be carried out to network functions (NFs) that make up a control plane. The PCF may also access a unified data repository (UDR) to access information relating to determining a policy.

A network exposure function (NEF) may serve to send or receive an event occurring in the mobile communication network and a supporting capability to or from the outside. For example, the NEF may perform a function of safely provisioning, to the core network, information of an external application to the core network, conversion of internal/external information, a function of storing a function received from another NF in the UDR and redistributing the function, or the like.

Unified data management (UDM) may perform creation of authentication and key agreement (AKA) authentication information for 3GPP security, processing of a user identity (ID), unconcealment of a subscriber concealed ID (SUPI), management of a list of NFs supporting the current UE, subscription management, short message service (SMS) management, or the like. The UDR may perform a function of storing and providing subscription information managed by the UDM, data structured for exposure, or application data associated with an NEF or service.

The UPF may serve to process actual user data, forward a packet created by the UE to an external data network, or process a packet to forward data brought in from the external data network to the UE.

Main functions provided by the UPF may include e.g., functions of performing an anchor role between radio access technologies (RATs), providing connectivity of a PDU session and an external data network, packet routing and forwarding, packet inspection, user plane policy application, traffic usage report preparation, buffering, or the like.

A network repository function (NRF) may support a service discovery function of the corresponding end point address and an NRF service through an NRF bootstrapping service. The NRF may receive an NF discovery request from an NF instance or a service capability provider (SCP), and transmit information of the discovered NF instance to the NF instance or the SCP. The NRF may maintain an NF profile of an available NF instance and supported service. The NRF may perform notification of an NF and SCP instance newly registered/updated/deregistered along with a potential NF service. The NRF maintains the status of the NF and the SCP.

The network data analytics function (NWDAF) may collect events or information occurring in the network, and send statistics, prediction or recommendation information relating to particular information to an NF, an application function (AF), or operation, administration and maintenance (OAM) by using an analysis tool or machine learning tool. For example, the NWDAF may perform a function of collecting data from the NF/AF/OAM, NWDAF service registration and metadata exposure, providing network analytics information to the NF/AF, or the like. Specifically, the NWDAF may analyze data through an intelligence technology, such as machine learning based on the collected network data and provide a resultant value of the analyzing to other 5G core network functions (e.g., NF, AF or OAM), thereby helping optimization and performance enhancement of each network function.

A UE radio capability management function (UCMF) may serve to store and provide mapping information between an ID of a radio access related function of the UE allocated by a public land mobile network (PLMN) or a manufacturer and an actual function in a dictionary form.

The AF may perform a function linked to the 3GPP core network to provide a service. The AF may be divided into a trusted one and an untrusted one, and the trusted AF may use services of NFs located in the core network without an extra intermediate function, such as the NEF. Representative functions provided by the AF may include routing of network traffic preferred by an application (application influence on traffic routing), using a network information exposure function, interaction with a policy framework for policy control, IP multimedia subsystem (IMS) related interaction, or the like.

The OAM may refer to a device for performing management over the overall mobile communication network including a BS and the core network. For example, the OAM may perform functions related to operation, management, maintenance, provisioning, troubleshooting, or the like, of the communication network.

Furthermore, the OAM may perform functions of monitoring and configuring the respective BSs or the core network to operate smoothly according to the design and the policy. The OAM may be a concept encompassing all the tools, procedures, or the like, related to management, and may not refer to a specific device but may include all the tools, software, procedures, or the like, used by a network administrator for administration.

The UE may be connected to a (R)AN to access a core network device of the network. The core network of the network (e.g., the 5G network) may include the aforementioned functions. The RAN may include a 5G-RAN and include a BS for providing the UE with a radio communication function.

The UE may access the AMF through the BS, and exchange control plane signaling messages with the 5G core network. Furthermore, the UE may access the UPF through the BS, and exchange user plane data with a data network (DN).

The DN may refer to a data network that provides an operator service, Internet access, or the 3rd party service, or the like. Hereinafter, the NF may be interchangeably used with an NF instance, a network entity, or an NF entity. In other words, in the following description, an operation method of the NF instance, network entity or NF entity may correspond to an operation method of the NF.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

FIG. 1 illustrates interaction between an SMF and a UPF according to an embodiment of the disclosure.

A device responsible for forwarding user data in a mobile communication network may receive rules or commands from a device located in the control plane and perform an operation related to user packet processing.

Referring to FIG. 1, an SMF located in the control plane may control the UPF by using a PFCP.

Operations between the SMF that serves to issue a control command and the UPF may be performed by referring to a procedure defined by the 3GPP. In the 3GPP, how the SMF sends a method of specifying a packet to be processed in the UPF, a method of forwarding the specified packet, or a method of processing a packet having the same QoS level at which the specified packet is to be processed may be defined.

The UPF serves to process packets, but receives the rules related to the processing from the SMF. The rules received from the SMF may go through a procedure for being allocated to a hardware part that processes actual packets or associated memory section.

When a command generated in the SMF is more frequent than a certain level, when there are frequent changes in rule or command, or when the number of installed rules is greater than a certain number, performance of a part that actually processes the packet may be deteriorated.

To efficiently send data generated by many UEs and applications, installing/updating/dropping packet processing rules for handling each traffic may be required. Methods of offloading certain rules to a hardware device to accelerate a packet processing capability of the data plane may be proposed.

The UPF offloading may include transferring UPF workloads from a host, such as a central processing unit (CPU) of a universal server to a programmable network device that provides an acceleration function. The programmable network device may include at least one of a programmable switch ASIC, a smart network interface card (smart NIC), an intelligent processing unit (IPU) or a data processing unit (DPU).

In an embodiment of the disclosure, a method of changing rules without a waste of resources or performance deterioration by effectively processing packet processing rules may be provided. A data plane session manager for performing control related to a command issued by the SMF to the UPF may be provided, and the data plane session manager may be implemented as a function corresponding to at least a portion of the SMF, a separate function from the SMF, or a partial function of the UPF. In the disclosure, the data plane session manager may correspond to an N4 session manager, an SBI interface manager or a data session manager.

FIG. 2 illustrates registering of a UPF in an NRF according to an embodiment of the disclosure.

The UPF may use an Nnrf_NFManagement service (e.g., Nnrf_NFManagement_NFRegister service or Nnrf_NFManagement_NFUpdate service) to manage an NF profile, information relating to the corresponding entity.

For example, referring to FIG. 2, in operation S210, the UPF transmits a request message regarding registration to the NRF. For example, the UPF transmits an Nnrf_NFManagement_NFRegister request message to the NRF.

An NF service consumer, e.g., a UPF instance, may notify the NRF of the NF profile when operating for the first time. The NF profile of the NF service consumer may be configured by an OAM system.

The UPF registers information relating to the corresponding entity (e.g., the UPF) in the NRF. The information relating to the corresponding entity may include at least one of an NF type, an NF instance ID, a fully qualified domain name (FQDN), an IP address of the NF, NF capacity, UPF provisioning information, a deep neural network (DNN), single network slice selection assistance information (S-NSSAI) or an SMF area ID.

In an embodiment of the disclosure, the information relating to the corresponding entity may further include at least one of information regarding a control message processing capability of the UPF or resource status information regarding control message processing.

The information regarding the control message processing capability of the UPF may include information about at least one of memory size for the rules, a maximum number of installable rules, a maximum rule update rate, or a preferred rule update rate.

The rule update rate may refer to the number of messages to be transmitted or received per a unit time or an update rate that may be handled by the UPF. For example, the rule update rate may indicate that a maximum of 100 rules may be installed for each second.

The resource status information regarding control message processing may include information about at least one of memory size for rules in use for a certain time, the number of rules installed for the certain time, a maximum rule update rate for the certain time, the number of control messages to be processed for the certain time or an allowable amount of allocation for the certain time. The resource status information regarding the control message processing may refer to context or analytics information relating to control processing of the UPF.

For example, the UPF may register memory size for rules in use at a certain time at present or in the past, the maximum number of installable rules at the certain time at present or in the past, a maximum rule update rate at the certain time at present or in the past, or a preferred rule update rate at the certain time at present or in the past.

When the UPF is shared by a plurality of SMFs or divided on a particular basis, such as a slice, a network instance, a UE or a UE group, or a particular service, the information regarding the control message processing capability may be determined based on each division level.

For example, when the UPF has 1,000 rules/s of the maximum rule update rate and is shared by three SMFs, the SMFs may receive different update rate information of 400 rules/s, 300 rules/s and 300 rules/s, respectively, according to a policy.

In operation S220, the NRF stores an NF profile of the NF service consumer.

The NRF may be marked as available to the NF service consumer. Whether the NF profile is to be integrity-protected by the NF service consumer and verified by the NRF may be determined by SA3.

In operation S230, the NRF transmits a response message regarding registration to the UPF. For example, the NRF may transmit an Nnrf_NFManagement_NFRegister response message to the UPF. The NRF may confirm NF registration through the Nnrf_NFManagement_NFRegister response message.

The UPF may update the NF profile by using an Nnrf_NFManagement_NFUpdate service. The UPF may transmit a request message for update, e.g., an Nnrf_NFManagement_NFUpdate request message, to the NRF.

The request message for update may include part or all of the aforementioned information relating to the corresponding entity. For example, in a case of replacing the whole NF profile, a whole NF profile may be provided. In a case of updating a portion of the NF profile, an NF profile element to be updated may be provided. The NRF may update the NF profile based on the request message for update.

The UPF may register information relating to a data network, capacity and functions that may be handled to operate as an NF instance in the NRF (or SCP), update the information, and make the information used in subsequent procedures. The NRF (or SCP) may send information relating to an entity of the UPF to the SMF.

The SMF may use a service provided by the NRF to obtain at least one of the information relating to the control message processing capability or the information relating to the control message processing state. For example, the service provided by the NRF may include at least one of an Nnrf_discovery service, an Nnwdaf_analyticsSubscription service or an Nnwdaf_analyticsInfo service.

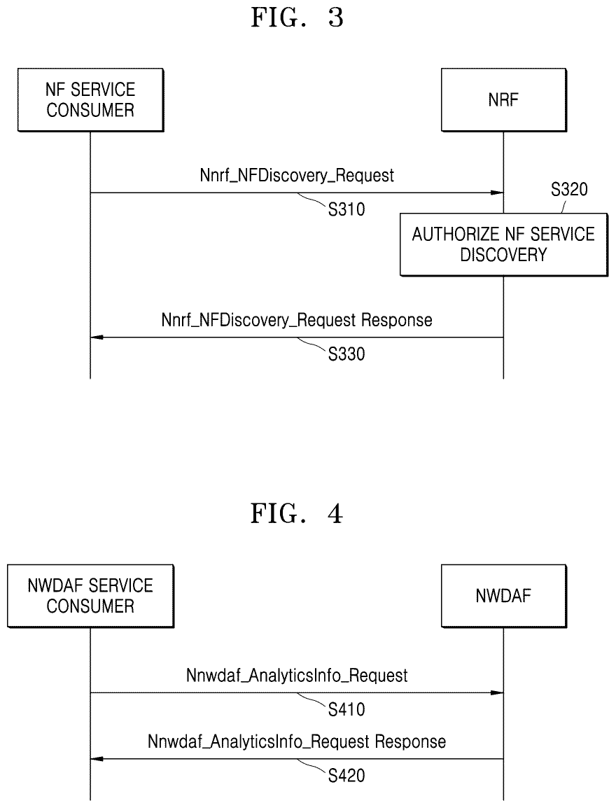

FIG. 3 illustrates an SMF obtaining information from an NRF according to an embodiment of the disclosure.

In response to receiving a request related to certain PDU session or data processing from the UE, the SMF may perform a UPF discovery procedure for selecting a UPF for processing user data of the UE and a procedure for selecting the UPF. The SMF may obtain information relating to a list or set of UPF instances that is able to process the corresponding user packet or session from the NRF (or SCP).

For example, referring to FIG. 3, in operation S310, an NF service consumer, e.g., the SMF, transmits a discovery request message to the NRF. The SMF may transmit Nnrf_NFDiscovery_Request to the NRF.

The request message may include one or more target NF service names, an NF type of a target NF, or an NF type of an NF service consumer. The discovery request message may optionally include at least one of a producer NF set ID, an NF service set ID, a subscription permanent identifier (SUPI), a data set identifier or data set identifiers, single network slice selection assistance information (S-NSSAI), a network slice identifier (NSI) ID or preference for a target NF location.

The request message may include at least one of an SMF area ID, a UE IPv4 address/IPv6 prefix, a supported access traffic steering, switching, splitting (ATSSS) steering function, a supported UPF event exposure service or a subscribable and supported event ID. When the UPF is able to expose NAT information, a UE IPv4 address/IPv6 prefix (e.g., common IP address) that may be seen from the DN may be further included.

The request message may provide a filter related to the control message processing capability to the NRF in additional filter information. The filter related to the control message processing capability may include at least one of a UPF rule memory size, the maximum number of installable rules, a maximum rule update rate, or a preferred rule update rate.

In operation S320, the NRF grants the NF service discovery.

The NRF may grant the discovery request, e.g., Nnrf_NFDiscovery_Request. Based on an expected NF/NF service profile and NF service consumer type, the NRF may determine whether the NF service consumer is able to discover an expected NF instance.

When the expected NF instance or NF service instance is released to a certain network slice, the NRF may grant the discovery request according to a search configuration of the network slice. The expected NF instance may be searched in an NF of the same network slice.

The filter may be used to reduce target UPF instances or more easily search for a UPF to be bound by the SCP. In a case that it is possible to dynamically update the information of the NRF, a filter provided for the NRF may include information about at least one of an amount of memory currently in use, the number of currently installed rules, or the average number of control messages currently processed.

The NRF may obtain the resource status information regarding control message processing in filter information. The resource status information regarding control message processing may include information about at least one of memory size for rules in use for a certain time, the number of rules installed for the certain time, a maximum rule update rate for the certain time, the number of control messages to be processed for the certain time or an allowable amount of allocation for the certain time. The resource status information regarding the control message processing may refer to context or analytics information relating to control processing of the UPF.

For example, it may include a memory size for rules used by the UPF at a certain time at present or in the past, the maximum number of installable rules at the certain time at present or in the past, a maximum rule update rate at the certain time at present or in the past, or a preferred rule update rate at the certain time at present or in the past.

When the discovery request is granted, the NRF may determine an NF instance set, i.e., a UPF instance set, which corresponds to Nnrf_NFDiscovery_Request and an internal policy of the NRF.

In operation S330, the NRF transmits a response message to the NF service consumer, e.g., the SMF.

The NRF may transmit the response message including an NF profile of the determined UPF instance(s), Nnrf_NFDiscovery_response to the SMF. The SMF may receive one or more UPF instances that may provide the corresponding UE or service from the NRF (or SCP). The response message may include an expiration date of the NF instance set and a discovery result.

The response message may also include, for each NF instance, an NF type, an NF instance ID, a fully qualified domain name (FQDN) or Internet protocol (IP) address of the NF instance, or a service instance list including each service when applicable. The service instance list may include service names, NF service instance IDs, and optionally, endpoint addresses.

The response message may further include at least one of information regarding a control message processing capability of the UPF or resource status information regarding control message processing.

The information regarding the control message processing capability of the UPF may include information about at least one of a memory size for the rules, a maximum number of installable rules, a maximum rule update rate, or a preferred rule update rate.

The resource status information regarding control message processing may include information about at least one of a memory size for rules in use for a certain time, the number of rules installed for the certain time, a maximum rule update rate for the certain time, the number of control messages to be processed for the certain time or an allowable amount of allocation for the certain time.

In a case that the information of the NRF is dynamically updated, the resource status information regarding control message processing may be sent to the SMF from the NRF. The resource status information regarding control message processing may refer to situation, context or analytics information relating to control processing of the UPF.

For example, the resource status information regarding control message processing may include a memory size for rules in use at a certain time at present or in the past, the maximum number of installable rules at the certain time at present or in the past, a maximum rule update rate at the certain time at present or in the past, or a preferred rule update rate at the certain time at present or in the past.

The resource status information regarding the control message processing may include analytics information or an expected value for a certain future point in time. It may include information about at least one of a memory size for rules in use at a certain time in the future, the number of rules to be installed at the certain time in the future, a maximum rule update rate at the certain time in the future or an allowable amount of allocation at the certain time in the future.

When the UPF is shared by a plurality of SMFs or divided on a particular basis, such as a slice, a network instance, a UE or a UE group, or a particular service, the information regarding the control message processing capability may be determined based on each division level.

For example, when the UPF has 1,000 rules/s of the maximum rule update rate and is shared by three SMFs, the SMFs may receive different update rate information of 400 rules/s, 300 rules/s and 300 rules/s, respectively, according to a policy.

The SMF may select a UPF appropriate for handling the corresponding session from among the received UPF instances. The SMF may select the UPF by taking into account at least one of the information regarding control message processing capability or the resource status information relating to control message processing along with such information as DNN, S-NSSAI, DN access identifier (DNAI), or the like.

The SMF may select the UPF by taking into account at least one of the control message processing capability of the UPF or resource status regarding control message processing. For example, the SMF may select the UPF by considering a UPF rule memory size, the number of installable rules, a maximum rule update rate, an amount of memory currently in use, the number of currently installed rules, the average number of control messages being currently processed along with such information as DNN, S-NSSAI, or DNAI.

The selected UPF may be used to forward actual data. The SMF may use the selected UPF to perform an operation, such as request for session establishment, change of rules of the existing session, or deletion of the existing session.

FIG. 4 illustrates an SMF obtaining information from a network data analytics function (NWDAF) according to an embodiment of the disclosure.

The NWDAF service consumer may use an Nnwdaf_Analytics service to request and receive information from the NWDAF. The NWDAF service consumer may include the SMF or the UPF. The Nnwdaf_Analytics service may include at least one of an Nnwdaf_AnalyticsSubscription service or an Nnwdaf_AnalyticsInfo service.

Referring to FIG. 4, in operation S410, the NWDAF service consumer transmits a request message regarding analytics information. For example, the NWDAF service consumer may transmit an Nnwdaf_AnalyticsInfo_Request message to the NWDAF.

The request message regarding analytics information may include at least one of a set of analytics IDs, a target of analytics reporting, analytics reporting parameters including e.g., a period of time to be subject to analytics, analytics filter information, a preferred level of accuracy of the analytics, a preferred level of accuracy per analytics subset, a time requiring the analytics, the requested maximum number of entities (max), a preferred sequence of results, the requested maximum number of SUPIs (SUPImax), an analytics metadata request, statistical attributes of the dataset, an output strategy, a data time window, a use case context, or a time window for record analytics and analytics accuracy request information.

In operation S420, the NWDAF service consumer receives a response message from the NWDAF.

The NWDAF service consumer may obtain analytics information by using at least one of an Nnwdaf_AnalyticsSubscription_Notify message or an Nnwdaf_AnalyticsInfo_Response message as a response message.

On receiving the request for analytics information, the NWDAF may determine whether the collection of new data is required. When the request is accepted, the response message may include at least one of analytics ID, a timestamp of the generation of the analytics information, an expiration date, a reliability level, a modified latency time, analytics metadata information, or analytics accuracy information. When the request is rejected, the response message may include an error response.

The NWDAF may obtain the analytics information by using a statistics model or a machine learning (ML) model. The analytics information may be associated with at least one of the information regarding a control message processing capability or the resource status information regarding control message processing.

The information regarding the control message processing capability may include information about at least one of a memory size for the rules, a maximum number of installable rules, a maximum rule update rate, or a preferred rule update rate.

The resource status information regarding control message processing may include information about at least one of a memory size for rules in use for a certain time, the number of rules installed for the certain time, a maximum rule update rate for the certain time, the number of control messages to be processed for the certain time or an allowable amount of allocation for the certain time. The resource status information regarding the control message processing may refer to context or analytics information relating to control processing of the UPF.

The resource status information regarding the control message processing may include analytics information or an expected value for a certain future point in time. For example, the resource status information regarding the control message processing may include information about at least one of a memory size for rules in use at a certain time in the future, the number of rules to be installed at the certain time in the future, a maximum rule update rate at the certain time in the future, the number of control messages to be processed at the certain time in the future or an allowable amount of allocation at the certain time in the future.

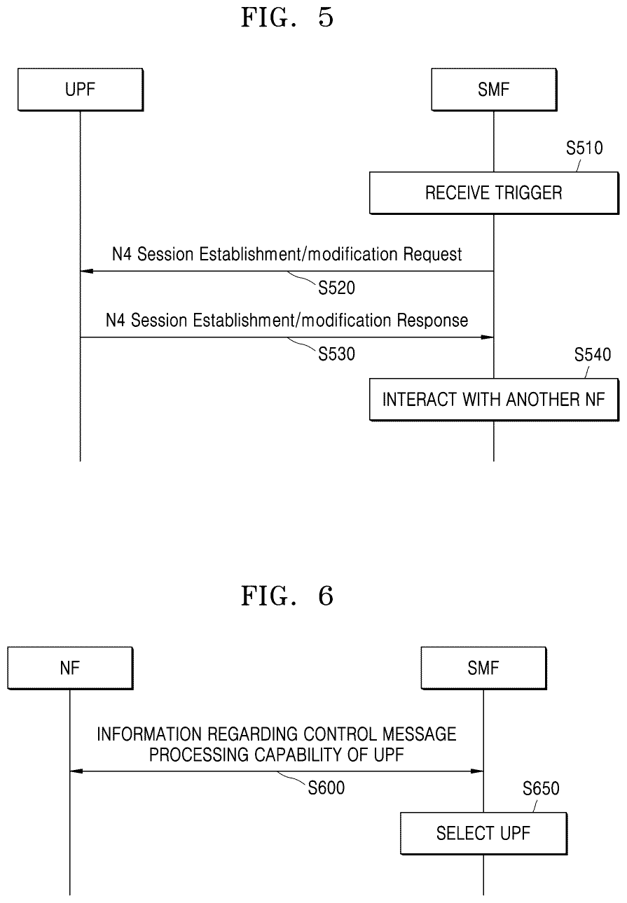

FIG. 5 illustrates exchange of information between an SMF and a UPF according to an embodiment of the disclosure.

Interface between the SMF and the UPF will now be described by taking an example of an N4 session for convenience of explanation, but the interface between the SMF and the UPF may be equally applied to a data plane session, SBI or other interfaces between the SMF and the UPF.

For example, the SMF and the UPF may establish the N4 session by using a PFCP, which may be represented in the form of a PFCP extended message. The SMF and the UPF may use an SBI for forwarding information, which may be represented in the form of a message that uses the SBI interface.

The SMF may transmit and receive N4 session management procedure messages to and from the UPF, and may control the function of the UPF by using the N4 session management procedure messages. For example, the SMF may generate, update and remove an N4 session context from the UPF.

The N4 session management procedure may include at least one of an N4 session establishment procedure, an N4 session modification procedure, an N4 session release procedure, or an N4 session level reporting procedure. The N4 session management procedure may be initiated by the SMF.

Parameters or information of the N4 session management procedure may be used to control a function of the UPF in the SMF and notify the SMF of an event occurring in the UPF. The N4 session establishment procedure and the N4 session modification procedure may provide control parameters to the UPF.

The N4 session release procedure may remove all the control parameters related to the N4 session. The N4 session level reporting procedure may notify the SMF of an event related to a PDU session detected by the UPF.

After selecting a UPF instance, the SMF may establish or modify the interface between the SMF and the UPF for generating a PDU session for the UPF, e.g., an N4 session.

Referring to FIG. 5, in operation S510, the SMF establishes a new PDU session or receives a trigger for changing the UPF for the established PDU session.

In operation S520, the SMF transmits a message requesting establishment/modification of an interface between the SMF and the UPF, e.g., an N4 session establishment/modification request message, to the UPF. The message requesting establishment/modification of the interface between the SMF and the UPF may include structured control information that defines how to operate the UPF.

The establishment/modification request message may further include request information for at least one of a control message processing capability or resource status. The request information may include information regarding at least one of a requested UPF rule memory size, the requested number of rules, a requested maximum rule update rate, a requested preferred rule update rate or the requested average number of control messages.

For example, the SMF may additionally send the UPF at least one of an expected memory size to be used in the N4 session to be currently established/modified for the UPF, the expected number of installable rules, an expected maximum rule update rate, an expected amount of memory for use, the expected maximum number of rules, or an expected average number of control messages.

In operation S530, the UPF transmits a message responding about establishment/modification of the interface between the SMF and the UPF, e.g., an N4 session establishment/modification response message to the SMF.

The N4 session establishment response message is a response to the received control information, and may include information to be provided by the UPF for the SMF. When the UPF uses the NWDAF, the NWDAF identified with an NWDAF instance ID may be added to the response message, and an analytics ID may be included for each NWDAF service instance.

The N4 session establishment response message may further include at least one of information regarding a control message processing capability or resource status information regarding control message processing.

The information regarding the control message processing capability may include information about at least one of a memory size for the rules, a maximum number of installable rules, a maximum rule update rate, or a preferred rule update rate.

The resource status information regarding control message processing may include information about at least one of a memory size for rules in use for a certain time, the number of rules installed for the certain time, a maximum rule update rate for the certain time, the number of control messages to be processed for the certain time or an allowable amount of allocation for the certain time. The resource status information regarding the control message processing may refer to context or analytics information relating to control processing of the UPF.

For example, the resource status information regarding control message processing may include a memory size for rules in use at a certain time at present or in the past, the maximum number of installable rules at the certain time at present or in the past, a maximum rule update rate at the certain time at present or in the past, or a preferred rule update rate at the certain time at present or in the past.

The information regarding the control message processing capability of the UPF may include at least one of a UPF rule memory size, the number of installable rules, a maximum rule update rate, an amount of memory currently in use, the number of currently installed rules, or an average number of currently processed control messages.

In a case that the request information may not be granted, the response message may additionally provide at least one of notification information indicating that it is not granted, a reason for not being granted, resource status information regarding control message processing or an allowable maximum amount of allocation. The information additionally provided may be used in a subsequent negotiation procedure between the SMF and the UPF.

For example, when the UPF has a capability of handling up to 1,000 rules and the SMF sends the UPF a request to use 100 rules for the N4 session to be currently established, the request information may be granted when the UPF is currently performing 800 rules.

On the other hand, when the UPF has a capability of handling up to 1,000 rules and the SMF sends the UPF a request to use 100 rules for the N4 session to be currently established, the UPF may transmit information indicating that the request information may not be granted to the SMF when the UPF is currently performing 950 rules. In addition, the UPF may transmit, to the SMF, a reason for not being granted, current usage, or an allowable maximum amount of allocation.

When the requested information is not granted, the SMF may use the additional information received from the UPF to perform operation S530 again for negotiation with the UPF.

In operation S540, the SMF interacts with an NF (e.g., an AMF or a PCF) that has triggered this procedure.

The SMF may use NWDAF related information, and forward the NWDAF related information to the PCF by using an SM policy modification procedure as a result of triggering a policy control request.

The N4 session establishment procedure may be used to generate an N4 session context for a PDU session in the UPF. The SMF may allocate an N4 session ID and provide this for the UPF. The N4 session ID may be stored by both the two entities, and may be used to identify the N4 session context during interaction. The SMF may store a relation between the N4 session ID and the PDU session for one UE.

The aforementioned procedure is based on N4 interface of 5G, but is merely an example and may be equally applied to a procedure through SBI between the UPF and the SMF. The UPF may have an SBI interface to expose at least one of the information regarding a control message processing capability or the resource status information regarding control message processing.

FIG. 6 illustrates an SMF selecting a UPF according to an embodiment of the disclosure.

Referring to FIG. 6, in operation S600, the SMF receives the information regarding the control message processing capability of the UPF from an NF.

The SMF may receive, from the NF, information to be used for selecting a UPF. The NF of FIG. 6 may include at least one of an NRF, an NWDAF or a UPF.

Receiving information by the SMF from the NF may correspond to at least one of obtaining information by the SMF from the NRF as shown in FIG. 3, obtaining information by the SMF from the NWDAF as shown in FIG. 4 or obtaining information by the SMF from the UPF as shown in FIG. 5, and some of the overlapping descriptions thereof will not be repeated.

The SMF may receive, from the NRF, a response message including an NF profile of the UPF instance(s), Nnrf_NFDiscovery_response. The response message Nnrf_NFDiscovery_response may include an expiration date of the discovery result and an NF instance set.

The response message may further include, for each NF instance, an NF type, an NF instance ID, an FQDN or IP address of the NF instance, or a service instance list including each service. The service instance list may include service names, NF service instance IDs, and optionally, endpoint addresses.

The response message Nnrf_NFDiscovery_response may further include at least one of information regarding a control message processing capability of the UPF or resource status information regarding control message processing.

The information regarding the control message processing capability of the UPF may include information about at least one of a memory size for the rules, a maximum number of installable rules, a maximum rule update rate, or a preferred rule update rate.

The resource status information regarding control message processing may include information about at least one of a memory size for rules in use for a certain time, the number of rules installed for the certain time, a maximum rule update rate for the certain time, the number of control messages to be processed for the certain time or an allowable amount of allocation for the certain time. The resource status information regarding the control message processing may refer to context or analytics information relating to control processing of the UPF.

For example, the resource status information regarding control message processing may include a memory size for rules in use at a certain time at present or in the past, the maximum number of installable rules at the certain time at present or in the past, a maximum rule update rate at the certain time at present or in the past, or a preferred rule update rate at the certain time at present or in the past.

When the UPF is shared by a plurality of SMFs or divided on a particular basis, such as a slice, a network instance, a UE or a UE group, or a particular service, the information regarding the control message processing capability may be determined based on each division level.

The resource status information regarding control message processing may include information about at least one of a memory size for rules in use for a certain time, the number of rules installed for the certain time, a maximum rule update rate for the certain time, the number of control messages to be processed for the certain time or an allowable amount of allocation for the certain time. The resource status information regarding the control message processing may refer to context or analytics information relating to control processing of the UPF.

For example, the resource status information regarding control message processing may include a memory size for rules in use at a certain time at present or in the past, the maximum number of installable rules at the certain time at present or in the past, a maximum rule update rate at the certain time at present or in the past, or a preferred rule update rate at the certain time at present or in the past.

The resource status information regarding the control message processing may include analytics information or an expected value for a certain future point in time. It may include information about at least one of a memory size for rules in use at a certain time in the future, the number of rules to be installed at the certain time in the future, a maximum rule update rate at the certain time in the future or an allowable amount of allocation at the certain time in the future.

The SMF may obtain a response message from the NWDAF by using an Nnwdaf_AnalyticsSubscription service or an Nnwdaf_AnalyticsInfo service. For example, the SMF may receive analytics information from the NWDAF by using at least one of an Nnwdaf_AnalyticsSubscription_Notify message or an Nnwdaf_AnalyticsInfo_Response message as a response message.

The analytics information may include at least one of the information regarding a control message processing capability or the resource status information regarding control message processing. The analytics information may be obtained by the NWDAF using a statistics model or an ML model.

The SMF may receive, from the UPF, a message responding about establishment/modification of the interface between the SMF and the UPF, e.g., an N4 session establishment/modification response message. The N4 session establishment/modification response message may further include at least one of information regarding a control message processing capability or resource status information regarding control message processing.

In a case that the requested information included in the message requesting establishment/modification of the interface between the SMF and the UPF may not be granted, the response message may additionally include at least one of notification information indicating that it is not granted, a reason for not being granted, resource status information regarding control message processing or an allowable maximum amount of allocation. The information additionally provided may be used in a subsequent negotiation procedure between the SMF and the UPF.

When the requested information is not granted, the SMF may use the additional information received from the UPF to transmit the message requesting establishment/modification of the interface between the SMF and the UPF again to perform negotiation with the UPF.

In operation S650, the SMF selects an UPF.

The SMF may select a UPF appropriate for handling the corresponding session from among the received UPF instances. In this case, the SMF may select the UPF by taking into account at least one of the control message processing capability of the UPF or resource status regarding control message processing.

For example, the SMF may select the UPF by considering a UPF rule memory size, the number of installable rules, a maximum rule update rate, an amount of memory currently in use, the number of currently installed rules, the average number of control messages being currently processed along with such information as DNN, S-NSSAI, or DNAI.

The SMF may use the selected UPF to perform an operation, such as request for session establishment, change of rules of the existing session, or deletion of the existing session. The selected UPF may be used to forward actual data to the UE.

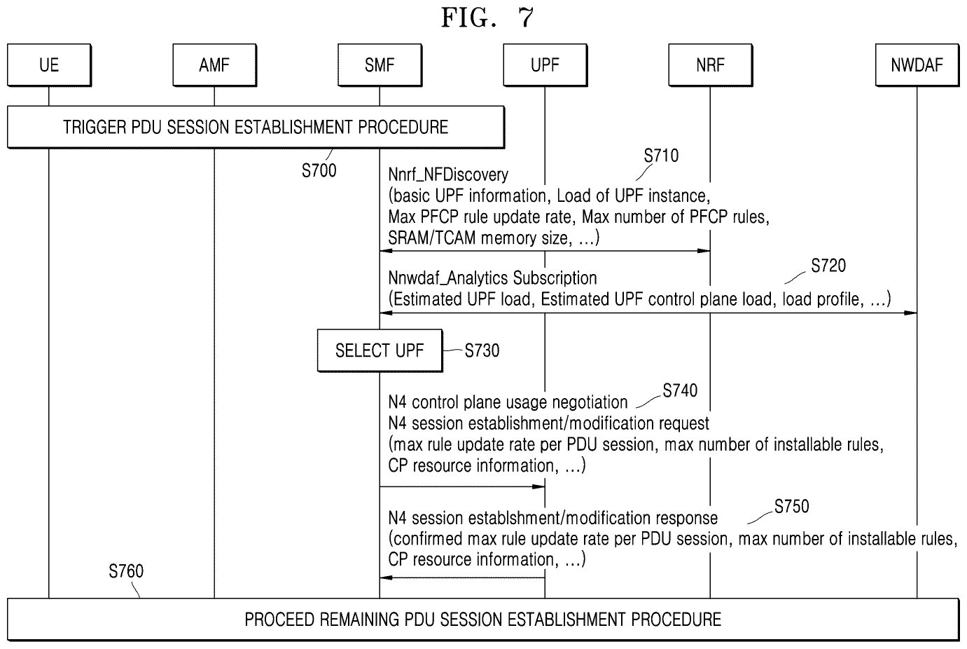

FIG. 7 is a sequence diagram of operations of an SMF and a UPF according to an embodiment of the disclosure.

Referring to FIG. 7, in operation S700, a PDU session establishment procedure may be triggered.

The UE may transmit, to an AMF, a PDU session establishment request message. The UE may generate a new PDU session ID to set up a new PDU session.

On receiving the PDU session establishment request message, the AMF may perform an SMF selection procedure. The AMF may transmit, to the selected SMF, an Nsmf_PDUSession_CreateSMContext or Nsmf_PDUSession_UpdateSMContext request message.

The SMF may transmit, to the AMF, an Nsmf_PDUSession_CreateSMContext or Nsmf_PDUSession_UpdateSMContext response message. When the SMF is able to process the PDU session establishment request, the SMF may generate an SM context and the response message may include an SM context ID. When the SMF does not grant the PDU session establishment, the response message may include a reason for the rejection. A PDU session authentication/authorization procedure may be performed.

In operation S710, the SMF may receive, from the NRF, an Nnrf_NFDiscovery response message including the UPF related information.

The SMF may receive, from the NRF, a response message including an NF profile of the UPF instance(s), Nnrf_NFDiscovery_response. The response message Nnrf_NFDiscovery_response may include an expiration date of the discovery result and an NF instance set.

The response message may further include at least one of information regarding a control message processing capability of the UPF or resource status information regarding control message processing.

The information regarding the control message processing capability of the UPF may include information about at least one of a memory size for the rules, a maximum number of installable rules, a maximum rule update rate, or a preferred rule update rate.

The resource status information regarding control message processing may include information about at least one of a memory size for rules in use for a certain time, the number of rules installed for the certain time, a maximum rule update rate for the certain time, the number of control messages to be processed for the certain time or an allowable amount of allocation for the certain time.

In a case that the information of the NRF is dynamically updated, the resource status information regarding control message processing may be sent to the SMF from the NRF. The resource status information regarding control message processing may refer to situation, context or analytics information relating to control processing of the UPF.

Operation S710 may correspond to what is described in connection with FIG. 3 or obtaining information from the NRF as shown in FIG. 6, and some of the overlapping descriptions thereof will not be repeated.

In operation S720, the SMF may receive, from the NWDAF, a response message including the UPF related information.

The SMF may obtain a response message from the NWDAF by using an Nnwdaf_AnalyticsSubscription service or an Nnwdaf_AnalyticsInfo service. For example, the SMF may receive analytics information from the NWDAF by using at least one of an Nnwdaf_AnalyticsSubscription_Notify message or an Nnwdaf_AnalyticsInfo_Response message as a response message.

The analytics information may include at least one of the information regarding a control message processing capability or the resource status information regarding control message processing. The analytics information may be obtained by the NWDAF using a statistics model or an ML model.

Operation S720 may correspond to what is described in connection with FIG. 4 or obtaining information from the NWDAF as shown in FIG. 6, and some of the overlapping descriptions thereof will not be repeated.

In operation S730, the SMF selects an UPF.

The SMF may select a UPF appropriate for handling the corresponding session from among the received UPF instances. In this case, the SMF may select the UPF by taking into account at least one of the control message processing capability of the UPF or resource status regarding control message processing.

For example, the SMF may select the UPF by considering a UPF rule memory size, the number of installable rules, a maximum rule update rate, an amount of memory currently in use, the number of currently installed rules, or the average number of control messages being currently processed along with such information as DNN, S-NSSAI, or DNAI.

The SMF may use the selected UPF to perform an operation, such as request for session establishment, change of rules of the existing session, or deletion of the existing session. The selected UPF may be used to forward actual data to the UE.

In operation S740, the SMF transmits a message requesting establishment/modification of an interface between the SMF and the UPF, e.g., an N4 session establishment/modification request message to the UPF.

The message requesting establishment/modification of the interface between the SMF and the UPF may include structured control information that defines how to operate the UPF.

The establishment/modification request message may further include request information for at least one of a control message processing capability or resource status. The request information may include information regarding at least one of a requested UPF rule memory size, the requested maximum number of rules, a requested maximum rule update rate, a requested preferred rule update rate or the requested average number of control messages.

For example, the SMF may additionally send the UPF at least one of an expected memory size to be used in the N4 session to be currently established/modified for the UPF, the expected number of installable rules, an expected maximum rule update rate, an expected amount of memory for use, the expected maximum number of rules, or an expected average number of control messages.

The UPF may determine whether the request information included in the establishment/modification request message is allowable.

In operation S750, the UPF transmits a message responding about establishment/modification of the interface between the SMF and the UPF, e.g., an N4 session establishment/modification response message to the SMF.

The N4 session establishment response message is a response to the received control information, and may include information to be provided by the UPF for the SMF. When the UPF uses the NWDAF, the NWDAF identified with an NWDAF instance ID may be added to the response message, and an analytics ID may be included for each NWDAF service instance.

The N4 session establishment response message may further include at least one of information regarding a control message processing capability or resource status information regarding control message processing.

The information regarding the control message processing capability may include information about at least one of a memory size for the rules, a maximum number of installable rules, a maximum rule update rate, or a preferred rule update rate.

The resource status information regarding control message processing may include information about at least one of a memory size for rules in use for a certain time, the number of rules installed for the certain time, a maximum rule update rate for the certain time, the number of control messages to be processed for the certain time or an allowable amount of allocation for the certain time. The resource status information regarding the control message processing may refer to context or analytics information relating to control processing of the UPF.

For example, the resource status information regarding control message processing may include a memory size for rules in use at a certain time at present or in the past, the maximum number of rules to be installed at the certain time at present or in the past, a maximum rule update rate at the certain time at present or in the past, or a preferred rule update rate at the certain time at present or in the past.

The information regarding the control message processing capability of the UPF may include at least one of a UPF rule memory size, the number of installable rules, a maximum rule update rate, an amount of memory currently in use, the number of currently installed rules, or an average number of currently processed control messages.

In a case that the request information may not be granted, the response message may additionally provide at least one of notification information indicating that it is not granted, a reason for not being granted, resource status information regarding control message processing or a maximum allowable amount of allocation. The information additionally provided may be used in a subsequent negotiation procedure between the SMF and the UPF.

When the requested information is not granted, the SMF may use the additional information received from the UPF to perform operation S740 again for negotiation with the UPF.

In operation S760, the rest of the PDU establishment procedure may be performed.

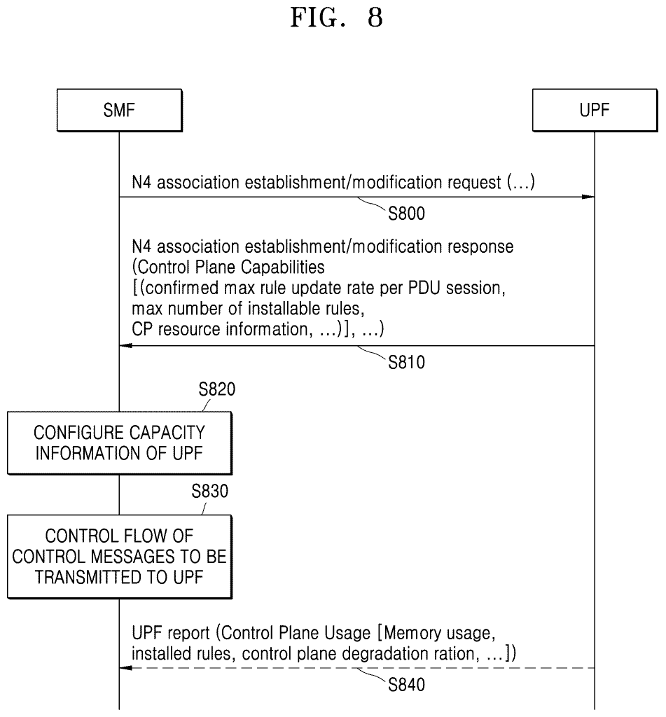

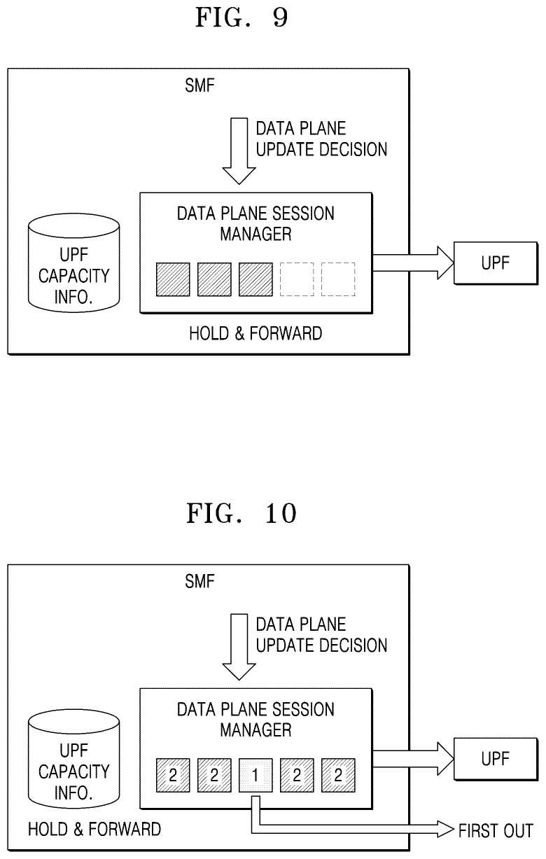

FIGS. 8 and 9 are diagrams illustrating how an SMF controls rule update message flows according to various embodiments of the disclosure.

The SMF may select a UPF. The SMF may perform an operation, such as request for new session establishment with the selected UPF, change of rules of the existing session, or deletion of the existing session. The selected UPF may forward actual data. In installing/updating rules for processing new packets with the selected UPF, the SMF may exchange information related to the capacity.

Referring to FIG. 8, in operation S800, the SMF transmits a message requesting establishment/modification of an interface between the SMF and the UPF, e.g., an N4 session establishment/modification request message, to the UPF. The message requesting establishment/modification of the interface between the SMF and the UPF may include a control message that defines how to operate the UPF.

The establishment/modification request message may further include request information for at least one of a control message processing capability or resource status. The request information may include information regarding at least one of a requested UPF rule memory size, the requested maximum number of rules, a requested maximum rule update rate, a requested preferred rule update rate or the requested average number of control messages.

For example, the SMF may additionally send the UPF at least one of an expected memory size to be used in the N4 session to be currently established/modified for the UPF, the expected number of installable rules, an expected maximum rule update rate, an expected amount of memory for use, the expected maximum number of rules, or an expected average number of control messages.

In operation S810, the UPF transmits an N4 session establishment/modification response message to the SMF.

The N4 session establishment response message is a response to the received control information, and may include information to be provided by the UPF for the SMF. When the UPF uses the NWDAF, the NWDAF identified with an NWDAF instance ID may be added to the response message, and an analytics ID may be included for each NWDAF service instance.

The N4 session establishment response message may further include at least one of information regarding a control message processing capability or resource status information regarding control message processing.

The information regarding the control message processing capability may include information about at least one of a memory size for the rules, a maximum number of installable rules, a maximum rule update rate, or a preferred rule update rate.

The resource status information regarding control message processing may include information about at least one of a memory size for rules in use for a certain time, the number of rules installed for the certain time, a maximum rule update rate for the certain time, the number of control messages to be processed for the certain time or an allowable amount of allocation for the certain time. The resource status information regarding the control message processing may refer to context or analytics information relating to control processing of the UPF.

For example, the resource status information regarding control message processing may include a memory size for rules in use at a certain time at present or in the past, the maximum number of rules to be installed at the certain time at present or in the past, a maximum rule update rate at the certain time at present or in the past, or a preferred rule update rate at the certain time at present or in the past.

The resource status information regarding the control message processing may include analytics information or an expected value for a certain future point in time. It may include information about at least one of a memory size for rules in use at a certain time in the future, the number of rules to be installed at the certain time in the future, a maximum rule update rate at the certain time in the future or an allowable amount of allocation at the certain time in the future.

In a case that the request information may not be granted, the response message may additionally provide at least one of notification information indicating that it is not granted, a reason for not being granted, resource status information regarding control message processing or a maximum allowable amount of allocation. The information additionally provided may be used in a subsequent negotiation procedure between the SMF and the UPF.

When the requested information is not granted, the SMF may use the additional information received from the UPF to perform operation S810 again for negotiation with the UPF.

The aforementioned procedure is based on N4 interface of 5G, but is merely an example and may be equally applied to a procedure through SBI between the UPF and the SMF. The UPF may have an SBI interface to expose at least one of the information regarding a control message processing capability or the resource status information regarding control message processing.

The SMF may receive at least one of the information relating to the control message processing capability or the resource status information regarding control message processing periodically or on request.

In operation S820, the SMF may configure/update capacity information.

The SMF may configure/update capacity information of the UPF based on at least one of the information regarding a control message processing capability or the resource status information regarding control message processing.

The capacity information may indicate at least one of a control message processing capability of the UPF, resource status regarding control message processing or UPF rule update capability information. For example, the SMF may set a rate and a maximum value of changing rules of the data plane.

The capacity information may be configured on a certain basis. For example, the capacity information may be configured for at least one of each slice, each DNN, each UE, each UPF instance or each session. The capacity information may be configured according to quality of service (QOS) or service level agreement (SLA).

The SMF may identify whether the performance related to the current UPF rules is deteriorated or the affordable extent of remaining resources. Taking into account the current network and a load level of the UPF, the capacity information may be changed according to negotiation at a certain time.

In operation S830, the SMF may control the flow of control messages to be transmitted to the UPF based on the capacity information of the UPF. In this case, the SMF may have already known the UPF capacity information to be configured to perform a control operation in the above operation by using the network manager or a local policy. In this case, the SMF may skip the procedure for obtaining/updating the capacity information and perform a flow control operation for control messages, an offloading control operation, a cache out control operation, or the like.

The SMF may temporarily store the control messages and control flows of the control messages. The SMF may control the sending of messages not to exceed the capacity of the UPF. For example, the SMF may control flows of the messages to be transmitted to the UPF to correspond to the number of messages to be sent to the UPF, a rate or the maximum number of installable rules.

When hardware offloading of the UPF is supported, flows of cache out or reinstalling may be controlled.

The SMF may control the flows of control messages by identifying information relating to a current session in which a command for the UPF is sent and a current amount of usage of a part that processes the command. This may prevent or reduce deterioration of the performance of the UPF from the influence of another SMF or another slice.

In an embodiment of the disclosure, a data session manager for performing control related to messages transmitted from the SMF to the UPF may be provided. The data session manager may perform the function of a buffer. The data session manager may include an N4 session manager, an SBI manager or a data plane session manager. The data session manager may be a function corresponding to at least a portion of the SMF, or may be implemented as a separate function from the SMF or a partial function of the UPF.

In operation S840, the SMF may receive, from the UPF, a UPF report.

The UPF report may include at least one of information regarding a control message processing capability, resource status information regarding control message processing or performance status (or healthy status).

The information regarding the control message processing capability may include information about at least one of a memory size for the rules, a maximum number of installable rules, a maximum rule update rate, or a preferred rule update rate.

The resource status information regarding control message processing may include information about at least one of a memory size for rules in use for a certain time, the number of rules installed for the certain time, a maximum rule update rate for the certain time, the number of control messages to be processed for the certain time or an allowable amount of allocation for the certain time. The resource status information regarding the control message processing may refer to context or analytics information relating to control processing of the UPF.

For example, the resource status information regarding control message processing may include a memory size for rules in use at a certain time at present or in the past, the maximum number of installable rules at the certain time at present or in the past, a maximum rule update rate at the certain time at present or in the past, or a preferred rule update rate at the certain time at present or in the past.

The resource status information regarding the control message processing may include analytics information or an expected value for a certain future point in time. It may include information about at least one of a memory size for rules in use at a certain time in the future, the number of rules to be installed at the certain time in the future, a maximum rule update rate at the certain time in the future or an allowable amount of allocation at the certain time in the future.

The UPF report may be agreed to be reported at certain intervals in an operation where the SMF establishes/modifies the session. The SMF may frequently fetch the required information from the UPF.

When the memory usage satisfies a certain condition, the UPF may agree with the SMF to proceed a procedure for reporting to the SMF. For example, when the memory usage is larger or smaller than the certain condition, the UPF may proceed the procedure for reporting to the SMF.

When the number of installed rules satisfies a certain condition, the UPF may agree with the SMF to proceed a procedure for reporting to the SMF. For example, when the number of installed rules is larger or smaller than a certain number, the UPF may proceed the procedure for reporting to the SMF.

When the performance of the data plane satisfies a certain condition, the UPF may agree with the SMF to proceed a procedure for reporting to the SMF. For example, when the performance is deteriorated below a certain performance level, the UPF may proceed the procedure for reporting to the SMF.

In a case that the UPF provides an SBI that may provide information, the UPF may send the UPF report to the SMF through an SBI interface.

Referring to FIG. 9, when the SMF determines to update the data plane, the SMF may control flows of the control messages based on capacity information of the UPF.

The SMF including the data plane session manager may temporarily store the control messages and control flows of the control messages. The SMF may control the sending of messages not to exceed the capacity of the UPF. For example, the SMF may control flows of the messages to be transmitted to the UPF to correspond to the number of messages to be sent to the UPF, a rate or the maximum number of installable rules.

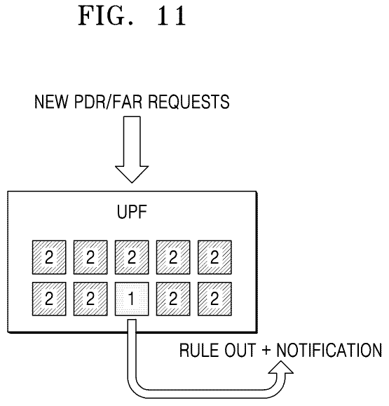

FIG. 10 illustrates forwarding messages on a priority basis according to an embodiment of the disclosure.

Referring to FIG. 10, priorities for rule application may be set for control messages to be transmitted to the UPF according to rule update priorities. The rule update priority may be set according to emergencies, QOS, slicing, requirement, or the like, of the message. A certain message may be applied first onto the data plane according to the rule update priority.

The emergencies may include an emergency call, data forwarding due to handover, or the like. A control message corresponding to the emergencies may be processed faster than normal messages.

The rule update priority may be set so that a message to retrieve a resource is processed faster. For example, when an N4 modification message indicates offloading or inactivation, the rule update priority may be set so that the N4 modification message may be prioritized.

To implement such a message forwarding method based on priority, two priorities may be used in the disclosure.

For the SMF to send messages, the rule update priority or rule installation priority may be set to send a certain message with priority. The SMF may specify and send a message that needs to be applied first among messages waiting to be sent to the UPF according to priorities.

The priorities may be allocated to rules. For example, a priority may be given to a rule, such as PDR/FAR in the N4 session establishment/modification procedure. Referring to FIG. 10, a rule corresponding to priority 1 may be dropped earlier than a rule corresponding to priority 2.

FIG. 11 illustrates priority-based message offloading according to an embodiment of the disclosure.

Referring to FIG. 11, the user plane or data plane component, e.g., the UPF, may employ not a single physical device but a plurality of physical devices or programmable network devices to use an acceleration function. In this case, the UPF may provide higher performance for certain rules. Priorities may be set so that the certain rules may be handled with priority.

The UPF may set maintenance priorities or offloading priorities. For example, in a case that there is a limit to the number of rules to be offloaded or accelerated, when there is a new request from the SMF, the UPF may drop some of the existing rules or move them to another UPF's processing space according to the priorities, and may install or perform rules included in the new request.

When the cache function or the acceleration function provided by the UPF, and a function of processing a limited number of rules with higher performance are supported, priorities may be used to select and apply a rule that uses the function.

When a new request has higher priority than the existing installed rules, the UPF may drop or de-accelerate the existing rules and install the new rule in the space.

When the number of installable rules is limited, the UPF may drop some of the existing installed rules according to the priorities and install the new rule. The UPF may perform reporting of a cached-out message.

When there is no existing installed rule having a lower priority than the rule to be installed, the UPF may send an error report to the SMF. When the priorities of the rules are the same, dropping, de-acceleration, or the like, of rules may be performed by using e.g., a round robin method or a least recently used (LRU) method.

When rules that define packet processing operations on the data plane are installed more or installed more frequently than a certain level, it may deteriorate the whole packet processing performance of the UPF.

In an embodiment of the disclosure, a number of packet processing rules or packet processing rule frequency that exceeds the capacity of the data plane may be controlled in the control plane. This may prevent or reduce performance deterioration that may occur due to installation of more rules than the certain level. Along with this, by applying certain rules with priority, service quality/experience of a service or UE having higher priority according to the policy may be improved.

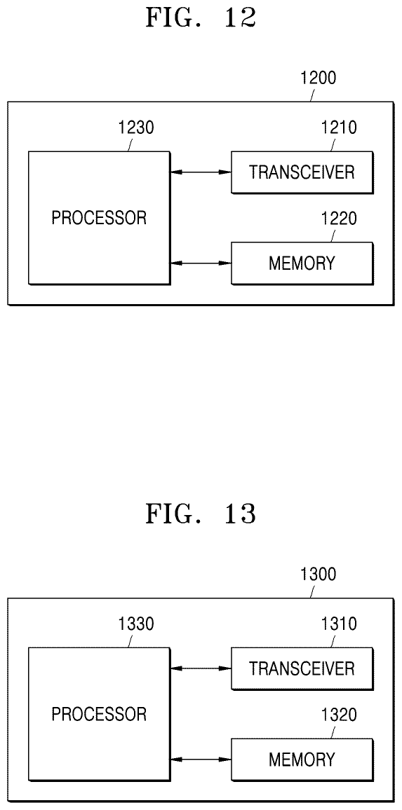

FIG. 12 is a block diagram of a network entity according to an embodiment of the disclosure.

Referring to FIG. 12, a network entity 1200 may be one of an AMF, an SMF, an NRF, an NWDAF, a PCF, a UDM, a network slice selection function (NSSF), an authentication server function (AUSF), a UDR, an AF and a DN. In the disclosure, the network entity 1200 may correspond to the aforementioned network entity as shown in FIGS. 1 to 11.

The network entity 1200 may include a transceiver 1210, memory 1220 and a processor 1230. The processor 1230, the transceiver 1210 and the memory 1220 of the network entity 1200 may operate according to the aforementioned operation method of the network entity 1200. Components of the network entity 1200 are not, however, limited thereto. The network entity 1200 may include more or fewer elements than described above.

In addition, at least one of the processor 1230, the transceiver 1210 or the memory 1220 may be implemented in the form of a single chip. The network entity 1200 may include an NF of the aforementioned AMF, SMF, NRF, NWDAF, PCF, UDM, NSSF, an AUSF, a UDR, an AF or a DN.

The transceiver 1210 is a collective term of a receiver of the network entity 1200 and a transmitter of the network entity 1200, and may transmit or receive a signal to or from a UE or another network entity. The signal to be transmitted to or received may include control information and data. For this, the transceiver 1210 may include an RF transmitter for up-converting the frequency of a signal to be transmitted and amplifying the signal and an RF receiver for low-noise amplifying a received signal and down-converting the frequency of the received signal. It is merely an embodiment of the transceiver 1210, and the elements of the transceiver 1210 are not limited to the RF transmitter and RF receiver. The transceiver 1210 may include a wired/wireless transceiver, including various components for signal transmission and reception.

In addition, the transceiver 1210 may receive a signal on a communication channel (e.g., a wireless channel) and output the signal to the processor 1230, or transmit a signal output from the processor 1230 on the communication channel.

Furthermore, the transceiver 1210 may receive a communication signal and output the communication signal to the processor 1230, and transmit a signal output from the processor 1230 to a UE or another network entity over a wired or wireless network.

The transceiver 1210 may allow the processor 1230 and the memory 1220 to exchange information with an external device, and may include PCIe, DMA, RDMA or Ethernet.

The memory 1220 may store a program and data required for operation of the network entity 1200. Furthermore, the memory 1220 may store control information or data included in a signal obtained by the network entity 1200. The memory 1220 may include a storage medium, such as read only memory (ROM), random access memory (RAM), a hard disk, compact disc ROM (CD-ROM), and a digital versatile disc (DVD), or a combination of the storage mediums.

The processor 1230 may control a series of processes for the network entity 1200 to be operated according to the embodiments of the disclosure. The processor 1230 may include at least one processor. Methods according to the claims of the disclosure or the embodiments of the disclosure described in the specification may be implemented in hardware, software, or a combination of hardware and software.

FIG. 13 is a block diagram of a network entity according to an embodiment of the disclosure.

Referring to FIG. 13, a network entity 1300 may include a UPF. In the disclosure, the network entity 1300 may correspond to the aforementioned UPF as shown in FIGS. 1 to 11.

The network entity 1300 may include a transceiver 1310, memory 1320, and a processor 1330. The processor 1330, the transceiver 1310 and the memory 1320 of the network entity 1300 may operate according to the aforementioned operation method of the network entity 1300. Components of the network entity 1300 are not, however, limited thereto. The network entity 1300 may include more or fewer elements than described above.

In addition, at least one of the processor 1330, the transceiver 1310 or the memory 1320 may be implemented in the form of a single chip.

The transceiver 1310 is a collective term of a receiver of the network entity 1300 and a transmitter of the network entity 1300, and may transmit or receive a signal to or from a UE or another network entity. The signal to be transmitted to or received may include control information and data. For this, the transceiver 1310 may include an RF transmitter for up-converting the frequency of a signal to be transmitted and amplifying the signal and an RF receiver for low-noise amplifying a received signal and down-converting the frequency of the received signal. It is merely an embodiment of the transceiver 1310, and the elements of the transceiver 1310 are not limited to the RF transmitter and RF receiver. The transceiver 1310 may include a wired/wireless transceiver, including various components for signal transmission and reception.

In addition, the transceiver 1310 may receive a signal on a communication channel (e.g., a wireless channel) and output the signal to the processor 1330, or transmit a signal output from the processor 1330 on the communication channel.

Furthermore, the transceiver 1310 may receive a communication signal and output the communication signal to the processor 1330, and transmit a signal output from the processor 1330 to a UE or another network entity over a wired or wireless network.

The transceiver 1310 may allow the processor 1330 and the memory 1320 to exchange information with an external device, and may include PCIe, DMA, RDMA or Ethernet.

The memory 1320 may store a program and data required for operation of the network entity 1300. Furthermore, the memory 1320 may store control information or data included in a signal obtained by the network entity 1300. The memory 1320 may include a storage medium, such as ROM, RAM, a hard disk, CD-ROM, TCAM, memory having rapidly accessible speed but having a small size, and a DVD, or a combination of the storage mediums.

The processor 1330 may control a series of processes for the network entity 1300 to be operated according to the embodiments of the disclosure, and may be referred to as a controller. The processor 1330 may include at least one processor. Methods according to the claims of the disclosure or the embodiments of the disclosure described in the specification may be implemented in hardware, software, or a combination of hardware and software.

The processor 1330 may include a CPU, an application-specific integrated circuit (ASIC), or a field programmable gate array (FPGA) capable of performing packet processing and any operations on the traffic.

According to an embodiment of the disclosure, a method performed by an SMF in a wireless communication system may be provided.

The method may include receiving information regarding a control message processing capability of a UPF from a network function. The method may include selecting a UPF based on the information regarding the control message processing capability of the UPF.

The information regarding the control message processing capability of the UPF may include information about at least one of a memory size for the rules, a maximum number of installable rules, a maximum rule update rate, or a preferred rule update rate.

The method may include selecting a UPF based on the information regarding a control message processing capability of the UPF and the resource status information regarding control message processing.

The resource status information may include information about at least one of a memory size for rules in use for a certain time, the number of rules installed for the certain time, a maximum rule update rate for the certain time, the number of control messages to be processed for the certain time or an allowable amount of allocation for the certain time.

The method may include transmitting request information regarding the control message processing capability of the UPF to the UPF. The request information may include information regarding at least one of a requested UPF rule memory size, the requested maximum number of rules, a requested maximum rule update rate, a requested preferred rule update rate or the requested average number of control messages.

The method may include receiving a response message from the UPF. The response message may include information indicating whether the request information is granted.

When the request information is not granted, the response message may include at least one of information about an allowable resource, resource status information regarding control message processing or information regarding a rejection reason.

The method may include updating capacity information of the UPF based on at least one of the information regarding a control message processing capability of the UPF or the resource status information regarding control message processing.

The method may include controlling the flow of control messages to be transmitted to the UPF based on the capacity information of the UPF.

Priorities for rule application may be set for the control messages to be transmitted to the UPF according to rule update priorities.

The method may include receiving at least one of information regarding a control message processing capability of the UPF or resource status information regarding control message processing from an NRF.

The method may include receiving at least one of the information regarding a control message processing capability of the UPF or resource status information regarding control message processing.

According to an embodiment of the disclosure, an SMF in a wireless communication system may be provided. The SMF may include a transceiver, and at least one processor connected to the transceiver.

The at least one processor may receive information regarding a control message processing capability of a UPF from an NF.

The at least one processor may select a UPF based on the information regarding the control message processing capability of the UPF.

The information regarding the control message processing capability of the UPF may include information about at least one of a memory size for the rules, a maximum number of installable rules, a maximum rule update rate, or a preferred rule update rate.

The at least one processor may select a UPF based on the information regarding the control message processing capability of the UPF and the resource status information regarding control message processing.

The resource status information may include information about at least one of a memory size for rules in use for a certain time, the number of rules installed for the certain time, a maximum rule update rate for the certain time, the number of control messages to be processed for the certain time or an allowable amount of allocation for the certain time.

The at least one processor may transmit request information regarding the control message processing capability of the UPF. The request information may include information regarding at least one of a requested UPF rule memory size, the requested maximum number of rules, a requested maximum rule update rate, a requested preferred rule update rate or the requested average number of control messages.

The at least one processor may receive a response message from the UPF. The response message may include information indicating whether the request information is granted.

When the request information is not granted, the response message may include at least one of information about an allowable resource, resource status information regarding control message processing or information regarding a rejection reason.

The at least one processor may be configured to update capacity information of the UPF based on at least one of the information regarding the control message processing capability of the UPF or the resource status information regarding control message processing.

The at least one processor may be configured to control the flow of control messages to be transmitted to the UPF based on the capacity information of the UPF.

Priorities for rule application may be set for the control messages to be transmitted to the UPF according to rule update priorities.

The at least one processor may be configured to receive at least one of information regarding a control message processing capability of the UPF or resource status information regarding control message processing from an NRF.

The at least one processor may be configured to receive at least one of the information regarding a control message processing capability of the UPF or resource status information regarding control message processing from an NWDAF.

An embodiment of the disclosure may be implemented or supported by one or more computer programs, which are formed of computer-readable program codes and may be embodied on a computer-readable medium.

Throughout the specification, the terms ‘application’ and ‘program’ may refer to one or more computer programs, software components, instruction sets, procedures, functions, objects, classes, instances, associated data, or part thereof, suitably implemented in computer-readable program codes. The computer-readable program codes may include various types of computer codes including source codes, target codes and executable codes.

The computer-readable medium may include various types of medium accessible by a computer, such as ROM, RAM, hard disk drive (HDD), compact disc (CD), digital video disc (DVD) or other various types of memory.

The computer-readable storage medium may be provided in the form of a non-transitory storage medium. The non-transitory storage medium is a tangible device, which may exclude wired, wireless, optical, or other communication links to transmit the transitory electric or other signals. The non-transitory storage medium does not discriminate between an occasion when data is semipermanently stored and an occasion when data is temporarily stored in the storage medium.

For example, the non-transitory storage medium may include a buffer that temporarily stores data. The computer-readable medium may be an arbitrary available medium that may be accessed by the computer, including volatile, non-volatile, removable, and non-removable mediums. The computer-readable medium includes a medium for storing data permanently, and a medium for storing data which can be overwritten afterward, i.e., rewritable optical disk or erasable memory device.

In an embodiment of the disclosure, the aforementioned method according to the various embodiments of the disclosure may be provided in a computer program product. The computer program product may be a commercial product that may be traded between a seller and a buyer.

The computer program product may be distributed in the form of a storage medium (e.g., compact disc read only memory (CD-ROM)), through an application store, directly between two user devices (e.g., smart phones), or online (e.g., downloaded or uploaded).

In the case of online distribution, at least part of the computer program product (e.g., a downloadable app) may be at least temporarily stored or arbitrarily created in a storage medium that may be readable to a device, such as a server of the manufacturer, a server of the application store, or a relay server.

Several embodiments have been described, but a person of ordinary skill in the art will understand and appreciate that various modifications can be made without departing the scope of the disclosure. For example, the aforementioned method may be performed in a different order, and/or the aforementioned systems, structures, devices, circuits, or the like, may be combined in different combinations from what is described above, or replaced or substituted by other components or equivalents thereof, to obtain appropriate results.

The programs (software modules, software) may be stored in RAM, non-volatile memory including flash memory, ROM, electrically erasable programmable ROM (EEPROM), magnetic disc storage device, CD-ROM, DVD or other types of optical storage device, and/or a magnetic cassette. Alternatively, the programs may be stored in memory including a combination of some or all of them. There may be a plurality of memories.

The program may also be stored in an attachable storage device that may be accessed over a communication network including the Internet, an intranet, a local area network (LAN), a wide area network (WAN), or a storage area network (SAN), or a combination thereof. The storage device may be connected to an apparatus performing the embodiments of the disclosure through an external port. In addition, a separate storage device in the communication network may be connected to the apparatus performing the embodiments of the disclosure.

In the embodiments of the disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

Thus, it will be apparent to those of ordinary skill in the art that the disclosure is not limited to the embodiments described, but can encompass not only the appended claims but the equivalents. For example, an element described in the singular form may be implemented as being distributed, and elements described in a distributed form may be implemented as being combined. For example, some operations in FIGS. 2 to 8 may be practiced in a combined form or in a distributed form.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a session management function (SMF) in a wireless communication system, the method comprising:
configuring capacity information of a user plane function (UPF) based on at least one of information regarding a control message processing capability of the UPF or resource status information regarding control message processing; and
controlling a flow of control messages to be transmitted to the UPF based on the capacity information of the UPF.

2. The method of claim 1, further comprising:
receiving, from a network function (NF), at least one of the information regarding the control message processing capability of the UPF or the resource status information regarding control message processing; and
selecting the UPF based on at least one of the information regarding the control message processing capability of the UPF or the resource status information regarding control message processing.

3. The method of claim 1, wherein the information regarding the control message processing capability of the UPF comprises information about at least one of a memory size for rules, a maximum number of installable rules, a maximum rule update rate, or a preferred rule update rate.

4. The method of claim 1, wherein the resource status information regarding control message processing comprises:
information about at least one of a memory size for rules in use for a certain time, a number of rules installed for the certain time;
a maximum rule update rate for the certain time; and
a number of control messages to be processed for the certain time or an allowable amount of allocation for the certain time.

5. The method of claim 1, further comprising:
transmitting, to the UPF, request information regarding the control message processing capability of the UPF,
wherein the request information comprises:
information regarding at least one of a requested UPF rule memory size,
a requested maximum number of rules,
a requested maximum rule update rate, and
a requested preferred rule update rate or a requested average number of control messages.

6. The method of claim 4, further comprising:
receiving a response message from the UPF,
wherein the response message comprises information indicating whether request information is granted.

7. The method of claim 6, wherein, when the request information is not granted, the response message comprises at least one of information about an allowable resource, resource status information regarding control message processing or information regarding a rejection reason.

8. The method of claim 1, wherein priorities for rule application are set for the control messages to be transmitted to the UPF according to rule update priorities.

9. The method of claim 2, wherein the receiving of the at least one of the information regarding the control message processing capability of the UPF or the resource status information regarding control message processing comprises receiving, from a network repository function (NRF), at least one of the information regarding the control message processing capability of the UPF or the resource status information regarding control message processing.

10. The method of claim 2, wherein the receiving, from the NF, of the at least one of the information regarding the control message processing capability of the UPF or the resource status information regarding control message processing comprises receiving, from a network data analytics function (NWDAF), at least one of the information regarding the control message processing capability of the UPF or the resource status information regarding control message processing.

11. A session management function (SMF) in a wireless communication system, the SMF comprising:
a transceiver; and
at least one processor connected to the transceiver,
wherein the at least one processor is configured to:
configure capacity information of a user plane function (UPF) based on at least one of information regarding a control message processing capability of the UPF or resource status information regarding control message processing, and
control a flow of control messages to be transmitted to the UPF based on the capacity information of the UPF.

12. The SMF of claim 11, wherein the at least one processor is further configured to:
receive, from a network function (NF), at least one of the information regarding the control message processing capability of the UPF or the resource status information regarding control message processing, and
select the UPF based on at least one of the information regarding the control message processing capability of the UPF or the resource status information regarding control message processing.

13. The SMF of claim 11, wherein the information regarding the control message processing capability of the UPF comprises information about at least one of a memory size for rules, a maximum number of installable rules, a maximum rule update rate, or a preferred rule update rate.

14. The SMF of claim 11, wherein the resource status information regarding control message processing comprises:
information about at least one of a memory size for rules in use for a certain time;
a number of rules installed for the certain time;
a maximum rule update rate for the certain time; and
a number of control messages to be processed for the certain time or an allowable amount of allocation for the certain time.

15. The SMF of claim 11,
wherein the at least one processor is further configured to:
transmit, to the UPF; and
request information regarding the control message processing capability of the UPF,
wherein the request information comprises:
information regarding at least one of a requested UPF rule memory size,
a requested maximum number of rules,
a requested maximum rule update rate, and
a requested preferred rule update rate or a requested average number of control messages.

16. The SMF of claim 14,
wherein the at least one processor is further configured to receive a response message from the UPF, and
wherein the response message comprises information indicating whether request information is granted.

17. The SMF of claim 16, wherein, when the request information is not granted, the response message comprises at least one of information about an allowable resource, resource status information regarding control message processing or information regarding a rejection reason.

18. The SMF of claim 11, wherein priorities for rule application are set for the control messages to be transmitted to the UPF according to rule update priorities.

19. The SMF of claim 12, wherein the at least one processor is further configured to receive, from a network repository function (NRF), at least one of the information regarding the control message processing capability of the UPF or the resource status information regarding control message processing.

20. The SMF of claim 12, wherein the at least one processor is further configured to receive, from a network data analytics function (NWDAF), at least one of the information regarding the control message processing capability of the UPF or the resource status information regarding control message processing.
